(19) United States
(12) Patent Application Publication
(10) Pub. No.: US 2025/0233697 A1
(43) Pub. Date: Jul. 17, 2025

(54) METHODS, SYSTEM, AND APPARATUS FOR RETRANSMISSION IN LARGE PROPAGATION DELAY WIRELESS COMMUNICATIONS

(71) Applicant: Huawei Technologies Co., Ltd., Shenzhen (CN)

(72) Inventors: Aman Jassal, Stittsville (CA); Amine Maaref, Ottawa (CA); Jianglei Ma, Ottawa (CA)

(21) Appl. No.: 19/086,961

(22) Filed: Mar. 21, 2025

Related U.S. Application Data
(63) Continuation of application No. PCT/CN2022/120895, filed on Sep. 23, 2022.

(51) Int. Cl. H04L 1/1829

(52) U.S. Cl. CPC H04L 1/1854; H04L 1/1835

(57) ABSTRACT

The present disclosure relates to data block retransmission in wireless communications, and particularly in wireless communications having a relatively large propagation delay. Some embodiments relate to memory management and may involve a maximum time period during which a data block that is to be communicated in a wireless communication network may remain in memory space at a user equipment (UE) to support a data block retransmission procedure. UE reporting of current occupancy status of the memory space is also or instead supported in some embodiments. Selective transmission or retransmission may be provided, and may involve reception occasions at which a UE may receive a data block retransmission or a transmission of a different data block.

### CROSS-REFERENCE TO RELATED APPLICATIONS

This application is a continuation of International Application No. PCT/CN2022/120895, filed on Sep. 23, 2022, entitled “METHODS, SYSTEM, AND APPARATUS FOR RETRANSMISSION IN LARGE PROPAGATION DELAY WIRELESS COMMUNICATIONS”, the contents of which are hereby incorporated by reference.

### TECHNICAL FIELD

The present application relates generally to wireless communications, and more specifically to retransmission of data in wireless communication systems having a relatively large propagation delay.

### BACKGROUND

In wireless communication systems, at least some mobile communication devices, such as a user equipment (UE), are embedded systems that have limited power and limited memory space. In particular regard to radio access technologies such as 4^{th} generation long term evolution (4G LTE) and 5^{th} generation new radio (5G NR), transport blocks (TBs) carrying UE-specific data are decoded by a UE and held in memory (commonly known as a “soft buffer”) until the TBs have been decoded correctly or a maximum number of retransmissions have been attempted. According to conventional techniques, soft buffer space is equally dimensioned for all hybrid automatic repeat request (HARQ) processes based on maximum TB size.

In current 5G NR systems, TBs are individually acknowledged by a UE within a given interval, and this interval is typically configured using the higher-layer signaling parameter dl-DataToUL-ACK. Additionally, HARQ in 5G NR is based on a “stop-and-wait” protocol, in which normal UE behavior is for the transmitter to wait for acknowledgement (ACK)/negative acknowledgement (NAK) feedback from the receiver before sending a new data packet; moreover, back-up procedures such as timers are in place to ensure that data packets are retransmitted in the absence of ACK/NAK feedback from the UE.

In non-terrestrial scenarios, propagation delays are expected to be significantly larger relative to decoding time, which creates a challenge for retransmission techniques developed from terrestrial scenarios. Decoded bits of a TB may remain in the soft buffer for at least the amount of time that a UE needs to complete processing related to TB reception and decoding, also referred to as TB-decoding-time. Incorrectly decoded bits may stay in the soft buffer for up to T=(TB-decoding-time*number of transmission attempts)+(2*propagation delay*number of retransmission attempts). This is the amount of time that corresponding HARQ processes are “locked out” for scheduling purposes, and the corresponding soft buffer space is unable to hold any further decoded bits, even if some of the corresponding soft buffer space for that HARQ process is free.

These soft buffer size and timing features are illustrative of aspects of conventional HARQ approaches that can be particularly challenging in wireless communications, especially in longer propagation delay scenarios such as in non-terrestrial network applications.

### SUMMARY

Conventional HARQ approaches do not provide for flexibility in how UE soft buffers are used in retransmission processes.

Some embodiments disclosed herein introduce a new signaling framework for managing how long data blocks such as TBs remain in a soft buffer, based on a quality of service (QoS) associated with the data for example.

Soft buffer space utilization is also considered herein, and some embodiments are related to providing efficient and continuous data communication in systems with potentially longer propagation delay, such as 6^{th} generation (6G) non-terrestrial network (NTN) systems.

The present disclosure also encompasses embodiments related to managing retransmissions, which may be particularly useful in communication systems with long propagation delay.

According to an aspect of the present disclosure, a method involves receiving, by a UE in a wireless communication network, signaling that indicates a maximum time period during which a data block that is to be communicated in the wireless communication network may remain in memory space at the UE to support a data block retransmission procedure; and communicating, by the UE, the data block in the wireless communication network.

Another method involves transmitting, to a UE by a network device in a wireless communication network, signaling that indicates a maximum time period during which a data block that is to be communicated with the UE may remain in memory space at the UE to support a data block retransmission procedure; and communicating the data block, by the network device with the UE.

In apparatus embodiments, an apparatus may include a processor and a non-transitory computer readable storage medium that is coupled to the processor. The non-transitory computer readable storage medium stores programming for execution by the processor.

A storage medium need not necessarily or only be implemented in or in conjunction with such an apparatus. A computer program product, for example, may be or include a non-transitory computer readable medium storing programming for execution by a processor.

Programming stored by a computer readable storage medium may include instructions to, or to cause a processor to, perform, implement, support, or enable any of the methods disclosed herein.

For example, the programming may include instructions to, or to cause a processor to: receive, by a UE in a wireless communication network, signaling that indicates a maximum time period during which a data block that is to be communicated in the wireless communication network may remain in memory space at the UE to support a data block retransmission procedure; and communicate, by the UE, the data block in the wireless communication network.

In another embodiment, programming includes instructions to, or to cause a processor to: transmit, to a UE by a network device in a wireless communication network, signaling that indicates a maximum time period during which a data block that is to be communicated with the UE may remain in memory space at the UE to support a data block retransmission procedure; and communicate the data block, by the network device with the UE.

Some embodiments disclosed herein may involve a maximum time period, as referenced in the descriptions of illustrative embodiments above. Other features may also or instead be provided, separately from or in combination with features related to such a time period.

For example, other embodiments may include features related to a candidate occasion at which a UE may receive (and/or a network device may transmit) signaling related to a retransmission of a data block.

Embodiments may also or instead include features related to memory space occupancy status. According to one such embodiment, a method involves: receiving, by a UE from a network device in a wireless communication network, a data block that is to be stored in memory space at the UE to support a data block retransmission procedure; and transmitting, by the UE to the network device, signaling to indicate a current occupancy status of the memory space.

A related transmit-side method may involve: transmitting, to a UE by a network device in a wireless communication network, a data block that is to be stored in memory space at the UE to support a data block retransmission procedure; and receiving, by the network device from the UE, signaling to indicate a current occupancy status of the memory space.

In apparatus or computer program product embodiments, programming stored on or in a non-transitory computer readable for execution by a processor may include instructions to, or to cause a processor to, perform such methods. For example, programming may include instructions to, or to cause a processor to, receive a data block by a UE from a network device in a wireless communication network, and transmit, by the UE to the network device, signaling to indicate a current occupancy status of memory space at the UE in which the a data block is to be stored to support a data block retransmission procedure. Programming may also or instead include instructions to, or to cause a processor to, transmit a data block to a UE by a network device in a wireless communication network, and receive, by the network device from the UE, signaling to indicate a current occupancy status of memory space at the UE in which the a data block is to be stored to support a data block retransmission procedure.

According to another aspect of the present disclosure, a system is provided. The system comprises a network device and a user equipment. The network device is configured to transmit a data block in a wireless communication network. The user equipment is in communication with the network device in the wireless communication network. The user equipment is configured to receive and store the data block in a memory space. The user equipment is further configured to flush the data block from the memory space on expiry of a maximum time period.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a block diagram illustrating 5G NR HARQ operation.

FIG. 6 is a signal flow diagram that provides an overview of various embodiments of the present disclosure.

FIG. 7 is a block diagram illustrating time until discard (TUD) according to an embodiment.

FIG. 8 is a block diagram illustrating TUD according to another embodiment.

FIG. 9 is a block diagram illustrating an example of memory space partitioning.

FIG. 10 is a block diagram illustrating an example of memory space dimensioning.

FIG. 11 is a block diagram illustrating another example of memory space partitioning.

FIG. 12 is a block diagram illustrating an example of a memory space occupancy report.

FIG. 13 is a block diagram illustrating another example of memory space partitioning.

FIG. 14 is a block diagram illustrating another example of memory space dimensioning.

FIG. 15 is a block diagram illustrating another example of memory space partitioning.

FIG. 16 is a block diagram illustrating another example of a memory space occupancy report.

FIG. 17 is a block diagram illustrating candidate retransmission reception occasion (CRRO) according to an embodiment.

FIG. 18 is a block diagram illustrating CRRO according to another embodiment.

FIG. 19 is a block diagram illustrating CRRO according to yet another embodiment.

FIG. 20 is a block diagram illustrating a further CRRO embodiment.

FIG. 21 is a block diagram illustrating application of TUD to communications between different UEs.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

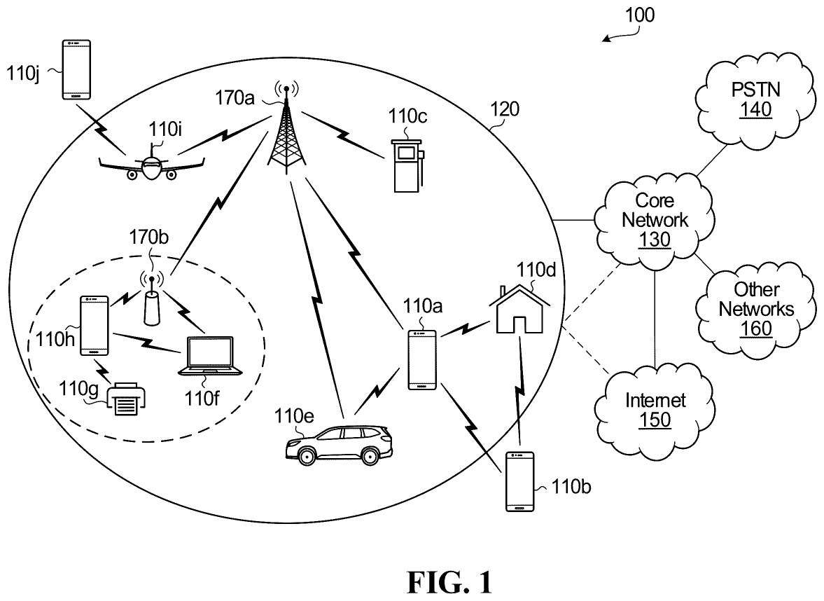

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

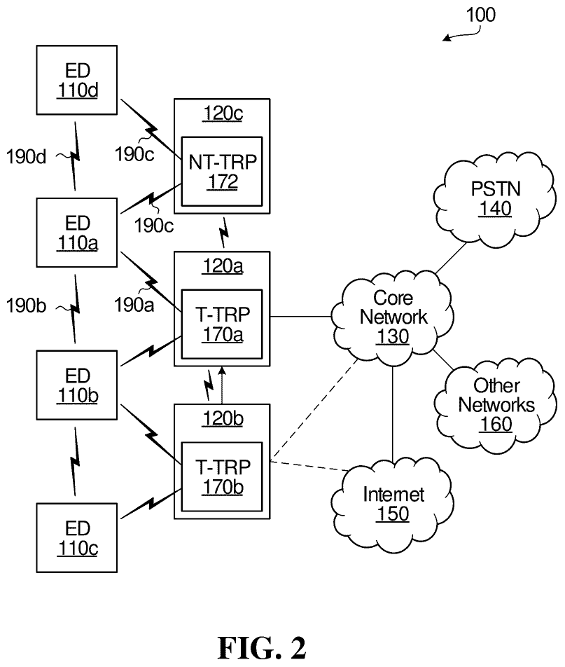

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over an non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

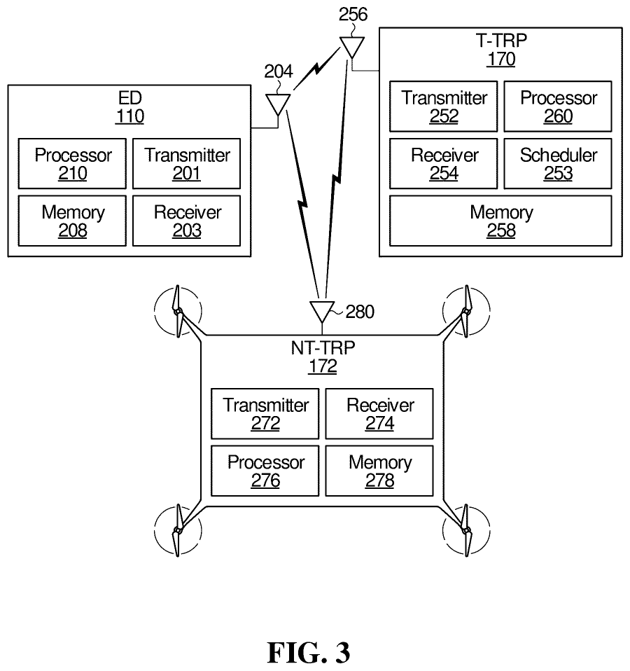

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

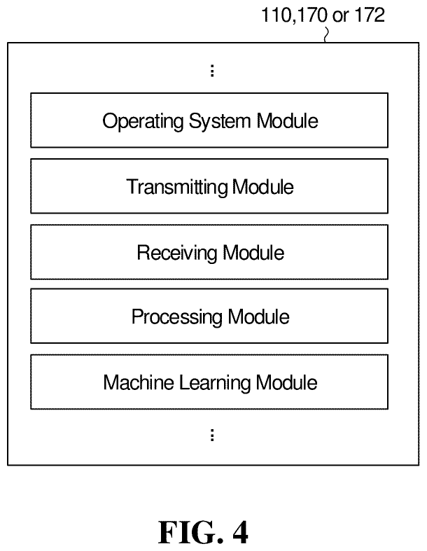

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Having considered communications more generally above, attention will now turn to particular example embodiments.

As briefly described above, propagation delays are expected to be significantly larger in non-terrestrial scenarios than in terrestrial scenarios, which can lead to incorrectly decoded bits of TBs being maintained in the soft buffer of a receiving device. This in turn results in locking out corresponding HARQ processes for longer periods of time even though soft buffer space may be available. A soft buffer is a buffer used by a UE to store decoded TB bits, where “soft” refers to the use of so-called soft-decoding algorithms in which outputs of a decoder include not only decoded bits but also reliability values such as log-likelihood ratio (LLR) of the decoded bits.

In current 5G NR systems, HARQ operation relies on a stop-and-wait protocol, in which a transmitter waits for a receiver to explicitly acknowledge receipt of a data packet before sending a new data packet. The 5G NR physical downlink control channel (PDCCH) carries a downlink control information (DCI) format with a new data indicator (NDI) field to indicate a new transmission (NDI=1) or to indicate a retransmission (NDI=0) for a given HARQ process identifier (ID). Toggling of the NDI field is based on ACK/NAK feedback sent by a receiving UE. This allows 5G NR to operate an asynchronous HARQ protocol.

HARQ processes in 5G NR belong to a HARQ entity of {8, 16, 32} processes, which operate in parallel. Each HARQ process is used to handle the reception of one TB at any given time at a UE side, or equivalently the transmission of one TB at any given time at a network side. These HARQ processes operate in “staggered” fashion to support continuous data reception at the UE, allowing the UE to decode different TBs in parallel. In conventional implementations, the soft buffer space that is allocated to a HARQ process cannot be used to receive another TB until the NDI field has been toggled to 1 for that HARQ process.

Soft buffer size or capacity is dimensioned based on the number of HARQ processes. The size of a soft buffer in 5G NR may be expressed as N*M*S, where N is the number of HARQ processes, M is the maximum TB size, and S is the number of TBs for spatial multiplexing. The number of HARQ processes is also dimensioned in a way to match the round-trip time of the communication system.

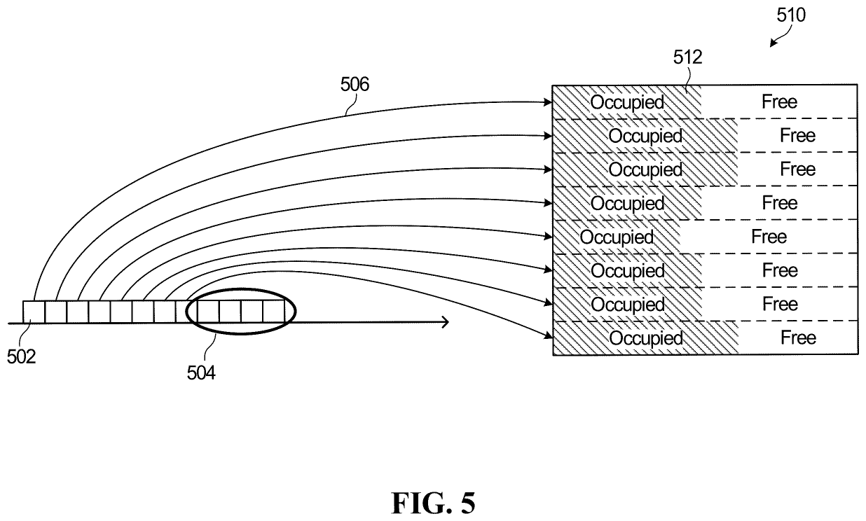

FIG. 5 is a block diagram illustrating 5G NR HARQ operation. In FIG. 5, a series or stream of TBs is to be transmitted, and one of the TBs is labelled at 502. The arrows at 506 are intended to illustrate mapping of HARQ processes to allocated soft buffer space in an example in which up to eight HARQ processes may be operating at any time. 510 denotes the soft buffer, and each row in 510 represents the space in the soft buffer that has been allocated to each HARQ process.

Soft buffer space for up to a maximum size TB is allocated to, and locked out for, each HARQ process, even though a scheduled TB may have a much smaller size. This is illustrated at 512 in FIG. 5, by showing only some of the soft buffer space that has been allocated to each HARQ process as being occupied. Despite the fact that the soft buffer clearly has available space in the example shown, the TBs 504 cannot be transmitted until soft buffer space for current HARQ processes has been cleared, which is dependent upon the UE sending ACK/NAK feedback to the network device that is transmitting previous TBs.

A HARQ approach as outlined in FIG. 5 relies on the use of HARQ processes to transmit downlink (DL) TBs to a UE. One disadvantage of using HARQ processes is that the size of the HARQ entity (which holds the HARQ processes) is fixed, and this prevents any flexibility in how the network can use the UE's DL soft buffer, which can be especially problematic in long propagation delay scenarios.

Static sharing of soft buffer space is one concern in that 5G NR relies on parallel HARQ process implementation to provide continuous data reception, but soft buffer space is equally dimensioned for all HARQ processes based on maximum TB size.

Another concern is overall retransmission efficiency, with a stop-and-wait protocol and TB-based ACK/NAK. TBs are acknowledged individually by a UE within a given interval or retransmissions are eventually sent in the case of no ACK/NAK feedback from the UE, and the transmitter must wait for either ACK feedback or a retransmission timer before retransmitting a TB.

Soft buffer occupancy can also be problematic, especially in long propagation delay scenarios. Decoded bits of a TB remain in the soft buffer for at least the amount of time that a UE needs to do processing related to TB reception and decoding.

Embodiments herein target problems with how to ensure efficient data communication, at UEs in 6G NTN systems for example. A new signaling framework is proposed for managing, based on traffic QoS for example, how long data blocks stay in memory. Memory space management, to maximize or at least improve memory space utilization for efficient or continuous data communications, is also provided in some embodiments. The present disclosure also encompasses embodiments related to managing retransmissions, and may be of particular advantage in long propagation delay scenarios.

Aspects of the present disclosure include:
TUD and related signaling to control how long data blocks for transmission, such as TBs, remain in memory for the purpose of a retransmission procedure;
memory occupancy or availability reporting, an example of which is referred to herein as soft buffer status report (SBSR) for soft buffer availability, may enable more effective management of memory space;
selective retransmission, using CRRO in some embodiments.

These and other aspects are explained in detail at least below.

Embodiments may be implemented in, or in conjunction with, any of various types of user communication devices, such as terminals, phones, vehicles, wearables, tablets, and any such devices that support radio access technologies such as 5G NR, future 6G systems, Wi-Fi, and satellite communication systems. Such communication devices are generally referenced herein as UEs, and a UE is intended to include all such user devices.

Terrestrial TRPs and non-terrestrial TRPs use physical layer control channels (PDCCH/physical uplink control channel (PUCCH), for example) and physical layer data channels (physical downlink shared channel (PDSCH)/physical uplink shared channel (PUSCH)) in order to communicate with UEs. These UEs are embedded systems where storage and battery space are limited, and therefore the buffer memory used to store decoded bits of received data blocks (received in DL PDSCHs for example) is also limited.

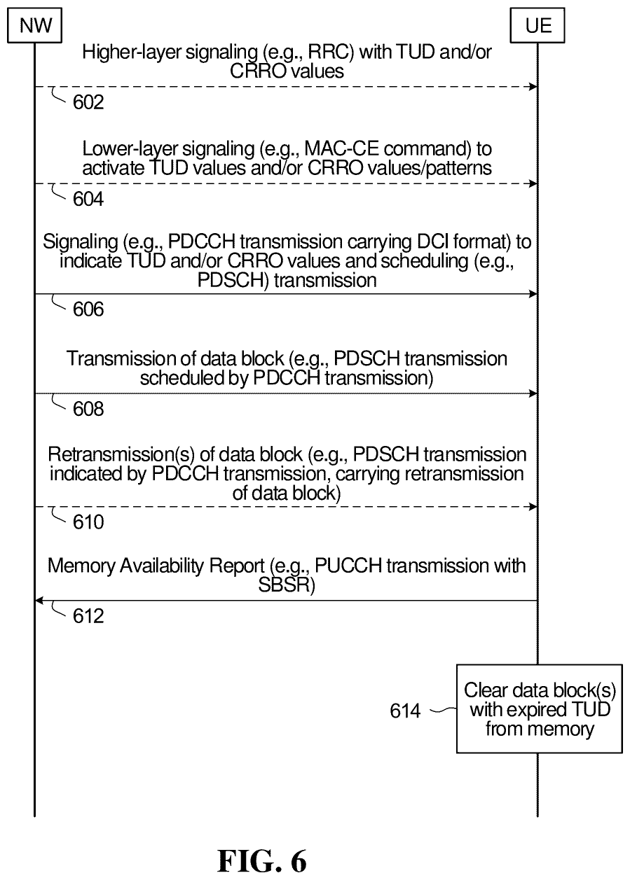

FIG. 6 is a signal flow diagram that provides an overview of various embodiments of the present disclosure. TUD, CRRO, and SBSR aspects are included in FIG. 6 by way of example, but need not be implemented together in all embodiments.

In FIG. 6, “NW” generally denotes a network. Solely for ease of reference, the present disclosure may describe a network performing actions or supporting or providing certain features. This is intended to generally capture the notion of network-based functions or features that may be provided or supported by any of various types of network devices, such as base stations, TRPs, etc.

In the example shown, at 602 a network device may transmit signaling, such as a higher-layer signaling message (e.g., in radio resource control (RRC) signaling) to the UE. Such signaling is received by the UE and indicates one or more TUD values, one or more CRRO values, or both. A signaling message, for example, may carry higher-layer configuration parameter values for the TUD and/or the CRRO. This allows the network device to instruct the UE about which values of TUD and/or CRRO may be activated or deactivated. The activation/deactivation of TUD and/or CRRO values means that the UE expects to receive a command or other indication related to TUD and/or CRRO after TUD/CRRO values have been configured.

The network device may also transmit signaling at 604, shown by way of example in FIG. 6 as lower-layer signaling, to activate one or more configured TUD values and/or CRRO values. A lower-layer signaling message (such as a medium access control-control element (MAC-CE) command) may carry an activation command with parameter values for the TUD and/or the CRRO, for example. Such signaling is received by the UE in this example, and allows the network to instruct the UE about which configured values of TUD and/or CRRO may be used for data block transmissions, and in subsequent signaling such as in DCI format messages carried within PDCCH transmission to schedule PDSCH transmissions. The UE may expect the network device to activate up to a certain number of values of TUD and/or CRRO, depending on how many values have been configured by the previous higher-layer signaling, for example.

Configuration at 602 and subsequent activation at 604 is one option, but there need not be separate configuration and activation in all embodiments.

Further signaling transmitted by the network device and received by the UE is shown at 606. A PDCCH transmission, for example, may carry a DCI format message with TUD and/or CRRO fields indicating certain values for transmission of a particular data block and scheduling a PDSCH transmission carrying that data block. In an embodiment, the presence of a TUD field or indicator in signaling related to a particular data block indicates to the UE that a new data block is to be transmitted, which in the example shown means that the PDSCH will carry a new transmission of a data block. The presence of a CRRO field or indicator in such signaling indicates to the UE where a candidate retransmission of the data block may be scheduled. The network device subsequently transmits the data block at 608, as a PDSCH transmission carrying the first transmission of the data block that is meant for the UE in the example shown, and the UE receives the transmission of the data block.

One or more retransmissions of the data block may be made by the network device and received by the UE at 610. In an embodiment, the network device may transmit a PDCCH carrying a DCI format message that does not include a TUD field and does not carry a CRRO field but schedules a PDSCH transmission carrying a retransmission of a data block, for example. In such an embodiment, the absence of the TUD field in the DCI format message indicates to the UE that the PDSCH will carry a retransmission of a data block that was previously transmitted and which is still in UE memory, such as in the UE's soft buffer. In this example the network device then transmits, and the UE receives, a PDSCH transmission carrying the retransmission of the data block that is meant for the UE.

Signaling that includes or otherwise indicates a memory availability report is shown by way of example at 612. The UE may transmit, and the network device may receive, a PUCCH carrying uplink control information (UCI) that carries or otherwise provides an SBSR indicating a percentage or other measure of occupied, or unoccupied, space in UE memory such as the UE's DL soft buffer. An SBSR may indicate the percentage of occupied space based on the associated QoS of the traffic flow, for example.

The UE continuously flushes from memory, such as the UE's soft buffer, any decoded bits of data blocks for which the TUD has expired, and 614 in FIG. 6 is intended to represent this flushing. Although shown in FIG. 6 after memory availability or occupancy reporting at 612, data block clearing at 614 is a continuous or ongoing process, and space that remains available from previously cleared data blocks and has not yet been re-used for other data blocks is taken into account at the time the SBSR is generated.

FIG. 6 is an illustrative and non-limiting example, and as noted elsewhere herein, aspects related to TUD, CRRO, and SBSR need not be implemented together in all embodiments. Each of these aspects is considered separately in detail below.

TUD may or may not include data block decoding time. For example, in some embodiments TUD is specified as an interval or period of time after the decoding time, and in this sense may be considered to be applied after decoding time or to not include decoding time. In the context of such an embodiment, and solely for illustrative purposes, consider an example in which a time unit used to express TUD is slots, where a slot is a group of, for example, orthogonal frequency division multiplexing (OFDM) symbols.

A DCI format message carried in a PDCCH transmission may be defined with a new field to indicate TUD. This new field may be called “Time Until Discard”, or may be given any other name. A value of this field indicates, explicitly or implicitly, how long a data block that is carried in a corresponding PDSCH transmission should stay in the UE's soft buffer. The time unit for the TUD may be, for example, an OFDM symbol, a group of OFDM symbols, a mini-slot, a group of mini-slots, a slot, a group of slots, seconds, milli-seconds, micro-seconds, etc. The present disclosure is not restricted to any particular time unit. A time unit is not the only value that may be carried by a TUD field. A value in this field may indicate an index or other identifier of a configured time unit value, for example, to provide an implicit indication of TUD.

A network device may configure candidate values for TUD, using higher-layer signaling such as RRC signaling for example, and may additionally activate or deactivate a subset of the candidate values for the TUD from within the set of configured candidate values for the TUD, using lower-layer signaling such as a MAC-CE command. The activation (or deactivation) of one or more candidate values for the TUD is done using an activation command sent within a MAC-CE command in some embodiments, to inform the UE about values that the TUD field in the DCI format message is allowed to take. Configuration and activation are shown by way of example at 602, 604, respectively, in FIG. 6.

Some restrictions may apply on DCI format, for instance: the presence of the TUD field in the DCI format message is an implicit indication that the PDSCH (scheduled by the corresponding PDCCH) carries a new transmission of a data block. Conversely, the absence of the TUD field in the DCI format message is an implicit indication that the PDSCH (scheduled by the corresponding PDCCH) carries a retransmission of a data block that was previously transmitted by the network device and whose decoded bits are still in the UE's soft buffer. If the DCI format message is inconsistent, then the UE may treat the DCI format message as invalid and discard all the information in the DCI format message, resulting in the UE not receiving and decoding the corresponding PDSCH transmission.

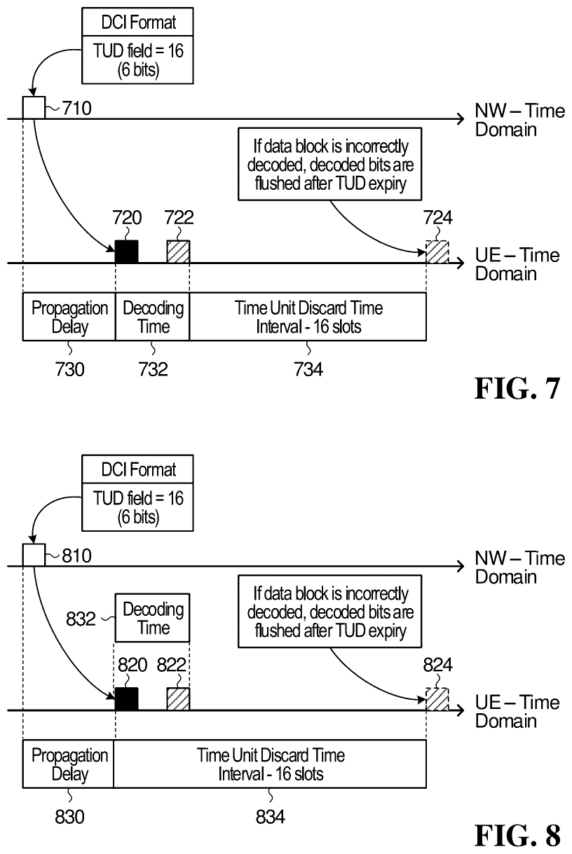

FIG. 7 is a block diagram illustrating TUD according to an embodiment. Network and UE time scales are shown, and as an example the TUD for a data block 710 is 16 slots. DCI format message and a 6-bit TUD field is shown in FIG. 7 for ease of reference and to illustrate that each data block is scheduled by a DCI format message in some embodiments, but 710 is intended to represent a data block for transmission, on PDSCH for example, rather than a PDCCH transmission with the DCI format message to schedule the data block 710 for transmission.

In FIG. 7, 720 represents reception of the data block at the UE, after a propagation delay 730. The decoding time 732 represents the amount of time needed by the UE to decode the data block. The TUD of 16 slots in this example is shown at 734, and is applied from the time at which the UE has determined that the data block has been incorrectly decoded, shown at 722. If the UE correctly decoded the data block after the decoding time, then the TUD may be stopped, and in any case is not applied, because the bits of the data block would then be forwarded and delivered to the UE's medium access control (MAC) layer, for disassembly and demultiplexing for example, after which the UE flushes the decoded bits from the UE's soft buffer.

If the UE has not correctly decoded the data block after the decoding time, then the data block is maintained in the UE's soft buffer for 16 slots. For example, denoting the slot corresponding to the end of the decoding time as S, and with the TUD for this data block being 16 slots, the data block will remain in the UE's soft buffer until the end of slot S+16. Starting from slot S+1 where the UE applies the TUD to the data block thus giving TUD=16, if the UE has not successfully decoded the data block: then the UE decrements the TUD by one for every passing slot. At slot S+2, if the UE has not successfully decoded the data block: then the UE decrements the TUD by one thus giving TUD=15. At slot S+3, if the UE has not successfully decoded the data block: then the UE decrements the TUD by one thus giving TUD=14, and so on until slot S+16 where the TUD for the data block is TUD=1 if the UE has not successfully decoded the data block. At slot S+17, if the UE still has not correctly decoded that data block and the TUD for the data block is decremented by one thus giving TUD=0, the UE flushes the decoded bits of the data block from its soft buffer.

In FIG. 7 and the example above, TUD is applied after data block decoding time. In another embodiment, TUD includes the data block decoding time, and may be considered to be applied before decoding time, or after a time of reception of a data block.

TUD features as described above may also or instead be provided in embodiments in which TUD includes decoding time or is applied before decoding time. TUD in such embodiments, as in other embodiments, is a time interval or period during which a data block is to remain in memory for the purpose of a retransmission procedure, but in a before decoding time embodiment this time interval or period is from a reception time of a data block rather than the end of the data block decoding time.

FIG. 8 is a block diagram illustrating TUD according to another embodiment, in which TUD is applied before decoding time. As in FIG. 7, network and UE time scales are shown in FIG. 8, and features in FIG. 8 that are similar to those in FIG. 7 are similarly labelled in FIG. 8. The TUD in FIG. 8 is 16 slots, and the DCI format message with a 6-bit TUD field is again shown in FIG. 8. 810 represents a data block for transmission, 820 represents reception of the data block at the UE after a propagation delay 830, and decoding time is shown at 832 and represents the amount of time needed by the UE to decode the data block. The TUD is shown at 834, and is applied from the time at which the data block is received and not from the time 822 at which the UE determines that the data block has been incorrectly decoded.

If the UE correctly decoded the data block after the decoding time, then the TUD may be stopped and is not applied because the bits of the data block would then be forwarded to the UE's MAC layer, after which the UE flushes the decoded bits from the UE's soft buffer.

If the UE has not correctly decoded the data block after the decoding time, then the data block is maintained in the UE's soft buffer for 16 slots after reception of the data block. Again denoting the slot corresponding to the end of the decoding time as S, and with the TUD for the data block being 16 slots, the data block will remain in the UE's soft buffer until the end of slot S+16-(decoding time). At slot S+17-(decoding time), if the UE still has not correctly decoded that data block, the UE flushes the decoded bits of the data block from its soft buffer.

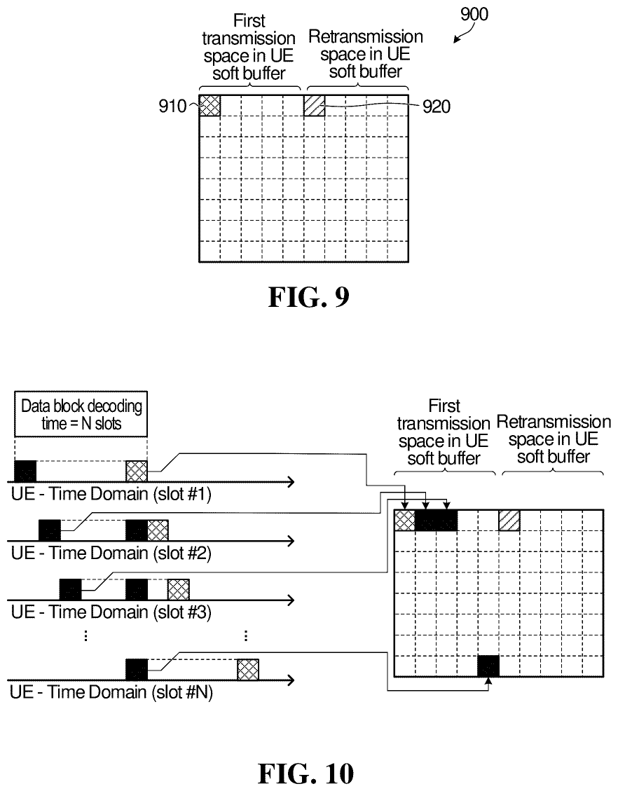

Turning now to memory availability or occupancy reporting, consider that a UE's DL soft buffer is used to receive data blocks from the network device, and data blocks may be new transmissions or retransmissions. Some of the DL soft buffer space is used to receive and store data block bits corresponding to a first transmission of the data block, while some of the DL soft buffer space is used to receive and store data block bits corresponding to a retransmission of the data block. FIG. 9 is a block diagram illustrating an example of memory space partitioning. In this example, soft buffer space 900 is partitioned into space for storing data block bits corresponding to a first transmission of a data block, and space for storing data block bits corresponding to retransmission of a data block. Each sub-block 910, 920 in FIG. 9 represents storage space for bits of one data block.

In an embodiment, data block bits are initially held in the first transmission space, at 910 for example. If the data block is correctly decoded, the decoded bits remain in this space until the decoded bits are forwarded to the MAC layer and are then flushed from the soft buffer. If the first transmission of the data block is not correctly decoded, then the decoded bits are moved into the retransmission space, at 920 for example, and are held there until TUD expiry, at which time they are flushed if the data block still has not been correctly decoded.

Regarding FIG. 9 and similar drawings described below, it should be noted that these drawings are intended to provide simple representations of aspects related to memory space management, but that actual implementations may vary. For example, memory space for storing bits of data blocks and/or first transmission space and retransmission space need not be in contiguous or adjacent memory locations. Memory space for a soft buffer or other short-term storage used during a decoding and retransmission procedure may be provided in multiple memory devices. These are examples of how implementations may vary from the intentionally simple representations shown in FIG. 9 and similar drawings, and other variations may be or become apparent to those skilled in the art.

For a data block transmission, the UE needs a decoding time in order to decode a data block, irrespective of the eventual result of that decoding. Supposing that the decoding time can be expressed as a positive integer number N (N>=1) of slots, then the first transmission soft buffer space is to be dimensioned such that the UE is able to process at least N data blocks in parallel in order to allow for continuous data reception at the UE. FIG. 10 is a block diagram illustrating an example of memory space dimensioning, in which first transmission memory space is sufficient to store data bits corresponding to first transmissions of N data blocks, and retransmission space is dimensioned identically.

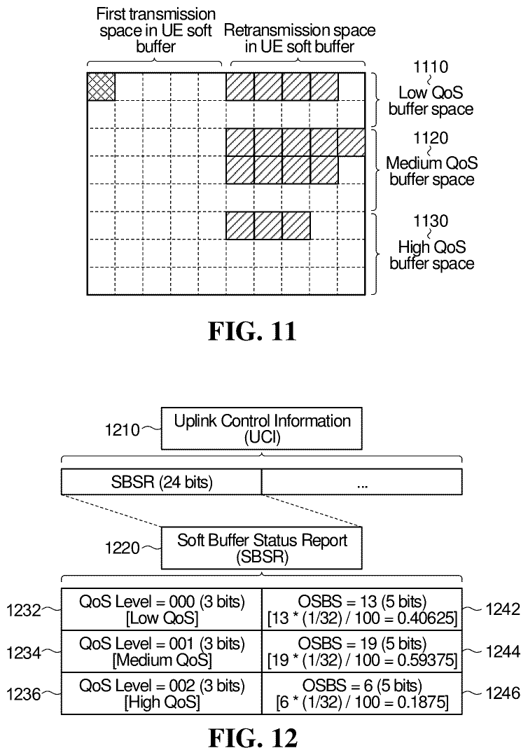

Retransmission space may be further partitioned into sub-partitions in some embodiments, based on QoS of a traffic flow to which a data block belongs for example. In some embodiments, the retransmission space is allocated to store decoding bits of a data block for which first transmission decoding was unsuccessful, because a cyclic redundancy check (CRC) or other decoding operation failed, for example. There may be multiple levels of QoS, such as three QoS levels including: low (least stringent), medium (moderately stringent), and high (most stringent), for example. FIG. 11 is a block diagram illustrating another example of memory space partitioning, consistent with respective sub-partitions for three QoS levels. The sub-partitioning shown in FIG. 11 provides a low QoS buffer space 1110, medium QoS buffer space 1120, and high QoS buffer space 1130 within the retransmission buffer space. Three sub-partitions as shown represent just one example, and other embodiments are possible, including embodiments with different relative sizes of sub-partitions, first transmission buffer space also or instead being sub-partitioned, and/or more or fewer sub-partitions, for example.

Although QOS sub-partitioning is not in any way dependent upon TUD and may be implemented independently of TUD, in some embodiments different levels of QoS are associated with different values of TUD, such that for different levels of QoS the maximum amount of time that a data block can remain in the DL soft buffer differ based on the level of QoS of the traffic flow to which the data block belongs. This association between QoS level and a value of TUD may be explicit or implicit, depending on the structure of signaling for TUD values for example. The following is one illustrative and non-limiting example of higher-layer signaling for TUD values, in which TUD is explicitly associated to QoS level of a traffic flow:

| SoftBufferConfig ::= SEQUENCE { | |
|---|---|
| tudQoSlist SEQUENCE (SIZE (1..maxNrofTUDQoS)) OF | |
| TUDQoSElement OPTIONAL | |
| } | |
| TUDQoSElement ::= SEQUENCE { | |
| tudValue | INTEGER (0..maxTUD), |
| QoSValue | ENUMERATED {low, medium, high} |

}

Considering an example in which maxNrofTUDQOS is set to 3 and maxTUD is set to 32, a network device may configure a UE with 3 QoS-TUD pairs using higher-layer signaling, with the following providing an illustrative and non-limiting example of such signaling:

```
SoftBufferConfig = {
  tudQoSlist = {
    TUDQoSElement = {tudValue = 8, QoSValue = low},
    TUDQoSElement = {tudValue = 16, QoSValue = medium},
    TUDQoSElement = {tudValue = 32, QoSValue = high}
  }
}
```

In order to assist the network with scheduling, the UE may generate a memory space occupancy or availability report, also referred to herein by way of example as an SBSR, to indicate DL soft buffer occupancy (or availability) to the network. In some embodiments, an SBSR is a report that indicates, for respective levels of QoS, a percentage or other measure of occupied soft buffer space (OSBS) holding decoded bits of data blocks. This is an example, and an SBSR may instead indicate a percentage or other measure of available soft buffer space. More generally, a memory space occupancy or availability report indicates an amount of memory space, which may be a relative measure such as a percentage or ratio or an absolute measure, that is currently occupied by stored (or is available to store) data block decoded bits. Occupancy status of memory space, as referenced herein, is intended to encompass not only an amount of memory space (such as a soft buffer) that is occupied. Occupancy status may also or instead relate to an amount of memory space (such as a soft buffer) that is available or unoccupied.

A percentage or other measure of occupied or available memory space may be reported in a quantized manner, depending on the format of an SBSR message and its expected length in number of bits for example. An SBSR message may additionally include an indication of QoS, for example in a field whose value indicates the QoS level corresponding to the memory space that is reported. In some embodiments, an SBSR may be or include a bitstream generated by a UE, which is then mapped to Uplink Control Information (UCI) and multiplexed with other UCI such as ACK/NAK bits, Retransmission Request (RTQ) bits, scheduling request (SR) bits, and/or channel state information (CSI) bits.

FIG. 12 is a block diagram illustrating an example of a memory space occupancy report, and in particular an SBSR 1220 in UCI 1210. The example in FIG. 12 reports retransmission space occupancy for current memory space usage as shown in FIG. 11. The low QoS buffer space is 40% occupied (due to 4 blocks out of 10 being occupied), the medium Qos buffer space is 60% occupied (due to 9 blocks out of 15 being occupied), and the high QoS buffer space is 20% occupied (due to 3 blocks out of 15 being occupied). The resolution of the OSBS in this example is set to 5 bits, for a quantization size or step of 1/32, which yields a report where: OSBS=13 to report 40% for low QoS, OSBS=19 to report 60% for medium QoS and OSBS=6 to report 20% for high QoS. The total payload of the SBSR is 24 bits in this example, which is mapped to the UCI.

In general, a memory space occupancy or availability report may indicate occupied or available memory space. In FIG. 12, the example report includes a respective indication 1242, 1244, 1246 for each of multiple (three in the example shown) memory space partitions or sub-partitions, and a respective indication 1232, 1234, 1236 of each of the partitions or sub-partitions.

FIG. 12 is a non-limiting example, and other embodiments are possible. For example, a memory space report may have a different length than the 24 bits shown, the report parts or sections for the partitions or sub-partitions being reported need not have the same length, the numbers of bits to indicate partitions or sub-partitions and/or memory occupancy or availability may be different than shown, and/or there may be more or fewer that three memory space partitions or sub-partitions being reported. Other variations may also be or become apparent. The present disclosure is not in any way limited to the example in FIG. 12.

Another embodiment related to memory occupancy or availability reporting focuses more specifically on transmitting very large data blocks. In the context of this embodiment, consider a previous example in which the time unit used to express the data block decoding time is a slot.

As also described elsewhere herein, a DL soft buffer is used to receive data blocks, some of the DL soft buffer space is used to receive and store the data block bits corresponding to a first transmission of a data block, and some of the DL soft buffer space is used to receive and store data block bits corresponding to a retransmission of the data block. DL soft buffer space for new transmissions and retransmissions can be statically or dynamically partitioned to accommodate various data block sizes, from very small data blocks on the order of a few bits for example, up to very large data blocks on the order of millions of bits for example.

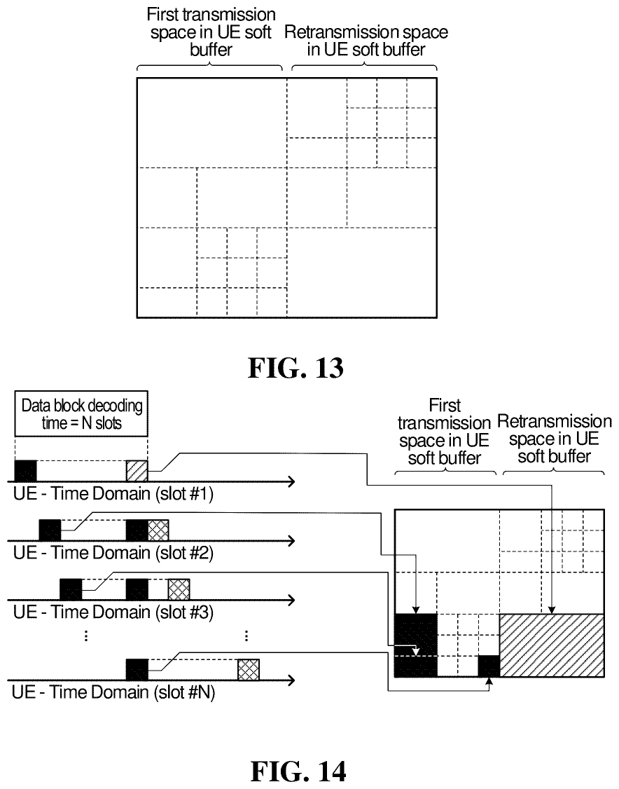

FIG. 13 is a block diagram illustrating another example of memory space partitioning, for data blocks of different sizes. The partitioning shown in FIG. 13 is similar to the partitioning shown in FIG. 9 in that soft buffer space is partitioned into space for storing data block bits corresponding to a first transmission of a data block and space for storing data block bits corresponding to retransmission of a data block. In the example in FIG. 13, however, data blocks are not the same size.

Otherwise the examples in FIG. 13 and FIG. 9 are similar. A soft buffer may be used and operated in a similar manner whether data blocks are the same size or different sizes. For example, data block bits may be initially held in the first transmission space (if not successfully decoded) and then moved into the retransmission space until TUD expiry, at which time they are flushed if the data block still has not been correctly decoded. If a data block is correctly decoded, then the decoded bits remain in the first transmission space or the retransmission space until the decoded bits are forwarded to the MAC layer and are then flushed from the soft buffer.

In order to provide for continuous data reception at the UE side, memory space should be dimensioned such that the UE is able to process data blocks in parallel during a data block decoding time. FIG. 14 is a block diagram illustrating another example of memory space dimensioning, in which first transmission memory space is sufficient to store data bits corresponding to first transmissions of N data blocks during a decoding time of N slots in this example, and retransmission space is dimensioned identically.

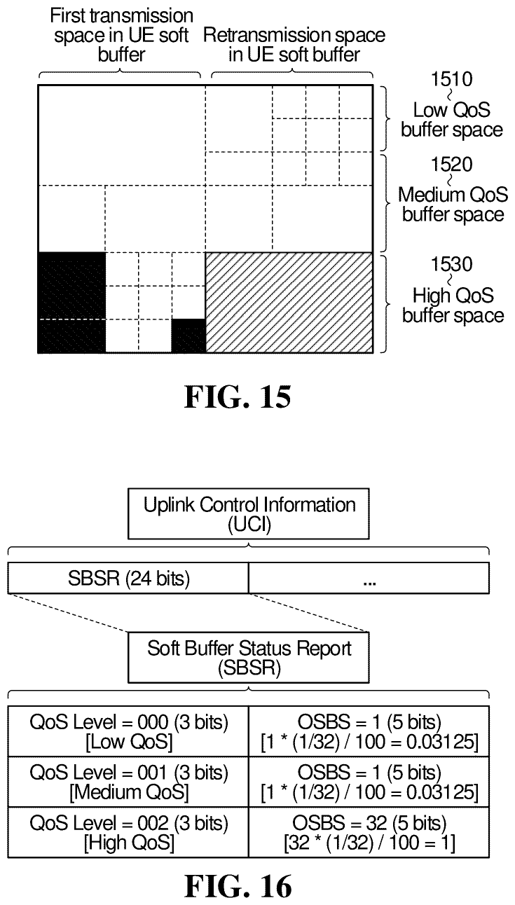

Retransmission space (and/or first transmission space) may be further partitioned into sub-partitions in some embodiments, based on QoS of a traffic flow to which a data block belongs for example. FIG. 15 is a block diagram illustrating another example of memory space partitioning, consistent with respective sub-partitions 1510, 1520, 1530 for three QoS levels, and is similar to the example shown in FIG. 11 except that the example in FIG. 15 accommodates different data block sizes. Three sub-partitions as shown represent just one example, and other embodiments are possible.

As described at least above, in some embodiments different levels of QoS are associated with different values of TUD. An association between QoS level and a value of TUD may be explicit or implicit. Examples of signaling that are provided elsewhere herein for TUD values associated with QoS level of a traffic flow may also or instead be applied to embodiments that support different data block sizes.

Memory space occupancy or availability reporting features disclosed elsewhere herein may be implemented in conjunction with embodiments that support different block sizes. FIG. 16 is a block diagram illustrating another example of a memory space occupancy report, similar to the example in FIG. 12. As in FIG. 12, FIG. 16 shows an SBSR in UCI as an example, but for reporting retransmission space occupancy as shown in FIG. 15. The low QoS buffer space is 0% occupied (due to 0 blocks out of 7 being occupied), the medium QoS buffer space is 0% occupied (due to 0 blocks out of 6 being occupied), and the high QoS buffer space is 100% occupied (due to one relatively larger block occupying the entire high QoS buffer space). The resolution of the OSBS in this example is set to 5 bits as in an example above, for a quantization size or step of 1/32. I this case a report indicates OSBS=1 (or 0 in another embodiment) to report 0% for low QoS, OSBS=1 (or 0 in another embodiment) to report 0% for medium QoS, and OSBS=32 to report 100% for high QoS. The total payload of the SBSR is 24 bits in this example, which is mapped to the UCI. This example SBSR indicates to a network device that the UE's high QoS buffer space is entirely occupied and the network device may then adapt its scheduling behavior by, for example, prioritizing retransmission of the very large data block and waiting for the UE's DL soft buffer space to clear up sufficiently before resuming normal prioritization and scheduling of lower QOS DL data blocks. This enables a greater level of flexibility and control over how UE soft buffer resources may be used, according to dynamic traffic conditions.

FIGS. 13 to 16, like FIGS. 9 to 12, are non-limiting examples of memory space partitioning, dimensioning, sub-partitioning, and reporting, and other embodiments are possible. Examples of variations have been described at least above with reference to FIGS. 9 to 12, and also apply to FIGS. 13 to 16. Other variations may also be or become apparent, and the present disclosure is not in any way limited to the examples in FIGS. 13 to 16.

Another aspect of the present disclosure relates to management of retransmissions, using what is referred to herein as CRRO. Consider an illustrative embodiment in which a time unit used to express the a CRRO is slots, where a slot is a group of, for example, 14 OFDM symbols.

A DCI format message may be defined, and carried in a PDCCH transmission, with a new field to indicate a retransmission reception occasion. This new field may be called “Candidate Retransmission Reception Occasion”, for example, although other names are also possible. In the current example of retransmission reception occasions expressed as slots, the value of this new field indicates, explicitly or implicitly, one or more PDSCH candidate reception occasions (relative to the PDSCH reception occasion scheduled by a DCI format message that carries the CRRO field) where a network device may send a retransmission of a data block. The time unit for the CRRO may be a slot as described above, or an OFDM symbol, a group of OFDM symbols, a mini-slot, a group of mini-slots, a group of slots, seconds, milli-seconds, micro-seconds, etc.

The network may configure candidate values for the CRRO using higher-layer signaling (e.g., RRC signaling), and the network may additionally activate or deactivate one or more candidate values for the CRRO from within the set of configured candidate values for the CRRO, using lower-layer signaling for example. The activation (or deactivation) of candidate values for the CRRO may involve using an activation command sent within a MAC-CE command for example, and informs the UE about the values that the CRRO field in the DCI format message (in this example) is allowed to take. Configuration and activation signaling are shown by way of example at 602, 604 in FIG. 6.

There may be restrictions on DCI format, for instance: the presence of the CRRO field in the DCI format message is conditioned upon the presence of the TUD field in the DCI format message. In other embodiments, the CRRO field may be present in the DCI format message while the TUD field is absent from the DCI format message. CRRO embodiments are not in any way dependent upon TUD and may be implemented with, or without, TUD. Combinations of higher-layer signaling (e.g., RRC signaling) and lower-layer signaling (e.g., MAC-CE signaling) may be used to indicate the number of candidate retransmission reception occasions.

As an example, consider an embodiment in which a network device provides higher-layer signaling to a UE to configure the UE with values for TUD and CRRO. This higher-layer signaling may be as follows in some embodiments:

PDCCH-Config ::= SEQUENCE {

| | |
|---|---|
| tudQoSlist | SEQUENCE (SIZE (1..maxNrofTUDQoS)) OF TUDQoSElement |
| OPTIONAL, | |
| crrolist | SEQUENCE (SIZE (1..maxNrofCRRO)) OF CRROElement OPTIONAL |

}
TUDQoSElement :: = SEQUENCE {

| | |
|---|---|
| tudValue | INTEGER (o..maxTUD), |
| QoSValue | ENUMERATED {low, medium, high} |

}
CRROElement ::= SEQUENCE {

| | |
|---|---|
| crroValue | INTEGER (o..maxCRRO), |

}

With maxNrofTUDQoS set to 3, maxTUD set to 32, maxNrofCRRO set to 2, and maxCRRO set to 16 as an illustrative example, the network may configure the UE with 3 QoS-TUD pairs and 2 CRRO values using higher-layer signaling, and the following provides one non-limiting example of such signaling:

```
PDCCH-Config = {
  tudQoSlist = {
    TUDQoSElement = {tudValue = 8, QoSValue = low},
    TUDQoSElement = {tudValue = 16, QoSValue = medium},
      TUDQoSElement = {tudValue = 32, QoSValue = high}
  },
  crrolist = {crroValue = 4, crroValue = 8}
}
```

This example also illustrates that QoS features may be implemented in conjunction with TUD and CRRO features. In an alternative example, the TUDQOSElement may be further expanded to include a tudQoSElementIdentity field to help identify a given TUD value and a CRROElement may be defined to include a crroElementIdentity field to help identify a given CRRO value. In an embodiment, higher-layer signaling may then be as follows:

```
PDCCH-Config = {
  tudQoSlist = {
    TUDQoSElement = {tudElementIdentity = 0, tudValue = 8, QoSValue = low},
    TUDQoSElement = {tudElementIdentity = 1, tudValue = 16, QoSValue = medium},
    TUDQoSElement = {tudElementIdentity = 2, tudValue = 32, QoSValue = high}
  },
  crrolist = {
    CRROElement = {crroElementIdentity = 0, crroValue = 4},
    CRROElement = {crroElementIdentity = 1, crroValue = 8}
  }
}
```

Consider now an example in which the network sends a MAC-CE command to the UE to activate two TUD values (e.g., 8 and 16) and two CRRO values (e.g., 4 and 8). The following provides an example of a MAC-CE command activating TUD values and CRRO values:

| | | |
|---|---|---|
| Bandwidth Part | Control Resource | Serving Cell |
| Identity [2 bits] | Set Identity [3 bits] | Identity [3 bits] |

| | |
|---|---|
| TUD/CRRO = 0 | ElementIdentity = 0 [7 bits] |

[1 bit]

| | |
|---|---|
| TUD/CRRO = 0 | ElementIdentity = 1 [7 bits] |

[1 bit]

| | |
|---|---|
| TUD/CRRO = 1 | ElementIdentity = 0 [7 bits] |

[1 bit]

| | |
|---|---|
| TUD/CRRO = 1 | ElementIdentity = 1 [7 bits] |

[1 bit]

This example MAC-CE command has a variable size where each row represents an octet, which is a sequence of eight bits. The first octet may be used to indicate the bandwidth part identity, the control resource set identity and the serving cell identity. From the second octet onwards, the activated TUD values and CRRO values are included. A given value of TUD or CRRO is considered to be “activated” in this example if there is an octet in the MAC-CE command which contains the corresponding TUD Element Identity or CRRO Element Identity. Conversely: a given value of TUD of CRRO is considered to be “deactivated” in this example if there is no octet in the MAC-CE command which contains the corresponding TUD Element Identity or CRRO Element Identity. Equivalently, the presence (respectively absence) of a given TUD Element Identity or CRRO Element Identity in this example indicates the activation status (or deactivation status) of the corresponding TUD value or CRRO value. Each octet in this example includes a one-bit field called “TUD/CRRO” and a seven-bit field called “ElementIdentity”. If the “TUD/CRRO” field is set to the value “0” then it indicates that the “ElementIdentity” field in the same octet is an activated TUD value for the corresponding TUD Element Identity. If the “TUD/CRRO” field is set to the value “1” then it indicates the “ElementIdentity” field in the same octet is an activated CRRO value for the corresponding CRRO Element Identity. In an alternative embodiment, consider an example of the MAC-CE command activating TUD values and CRRO values as follows:

| Bandwidth Part | | Control Resource Set Identity | | | Serving Cell Identity | | |
|---|---|---|---|---|---|---|---|
| Identity [2 bits] | | [3 bits] | | | [3 bits] | | |
| TUD | TUD | TUD | Reserved | Reserved | Reserved | Reserved | Reserved |
| Element | Element | Element | [1 bit] | [1 bit] | [1 bit] | [1 bit] | [1 bit] |
| ID o | ID 1 | ID 2 | | | | | |
| [1 bit] | [1 bit] | [1 bit] | | | | | |
| CRRO | CRRO | Reserved | Reserved | Reserved | Reserved | Reserved | Reserved |
| Element | Element | [1 bit] | [1 bit] | [1 bit] | [1 bit] | [1 bit] | [1 bit] |
| ID o | ID 1 | | | | | | |
| [1 bit] | [1 bit] | | | | | | |

This example MAC-CE command has a variable size where each row represents an octet. The first octet may be used to indicate the bandwidth part identity, the control resource set identity and the serving cell identity. From the second octet onwards, the activated TUD values and CRRO values are included, where the second octet is used to indicate the activated values of TUD and the third octet is used to indicate the activated values of CRRO. A given value of TUD or CRRO is considered to be “activated” in this example if the corresponding bit for the TUD element or CRRO element is set to “1”. Conversely: a given value of TUD of CRRO is considered to be “deactivated” in this example if the corresponding bit for the TUD element or CRRO element is set to “0”. Equivalently the indication of TUD Element ID or CRRO Element ID with a “1” indicates the activation status of the corresponding TUD value or CRRO value and the indication of TUD Element ID or CRRO Element ID with a “0” indicates the deactivation status of the corresponding TUD value or CRRO value. Reserved bits are used for padding and are set to “0” (or another predetermined value) by default.

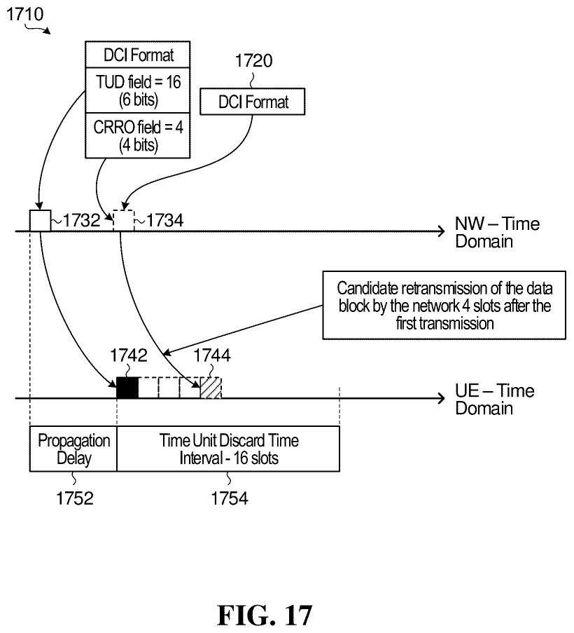

Referring now to FIG. 17, which is a block diagram illustrating CRRO according to an embodiment, network and UE time scales are shown, and as an example the TUD for a data block 1732 is 16 slots. DCI format message with a 6-bit TUD field and a 4-bit CRRO field is shown in FIG. 17 at 1710 for ease of reference, but as in other similar drawings 1732 is intended to represent a data block for transmission, on PDSCH for example, rather than a PDCCH transmission with the DCI format message to schedule the transmission 1732. Similarly, another DCI format message is shown at 1720 to represent scheduling of a retransmission, but 1734 is intended to represent a data block retransmission.

1742 in FIG. 17 represents reception of the data block at the UE, after a propagation delay 1752. The TUD of 16 slots is shown at 1754, and is applied from the time at which the data block transmission is received at 1742 in this example. A candidate retransmission of the data block is shown at 1734, and possible reception thereof (a reception occasion) is shown at 1744.

In an embodiment, the UE may first receive a PDCCH transmission carrying a DCI format message with TUD=16 and CRRO=4 as shown, but in another embodiment different values may be used to implicitly indicate TUD and/or CRRO. For example, values such as TUD=1 and CRRO=0 may be used to provide implicit indications, in the sense that TUD=1 refers to the second activated TUD value in the signaling example above (TUD=16), while CRRO=0 refers to the first activated CRRO value in the signaling example above (CRRO=4). This DCI format message schedules a PDSCH transmission carrying a first transmission of a TB, shown at 1732, for which TUD=16. This DCI format message also instructs the UE about a candidate slot indicated by CRRO=4 where a retransmission 1734 for the same data block may be received.

In other embodiments, the DCI format message 1720 scheduling a retransmission of a data block may carry a CRRO field to indicate a candidate slot to the UE where the network may transmit another retransmission of the same data block. Some restrictions may apply, for example if the CRRO in the DCI format message corresponds to a slot by which time the TUD for the corresponding data block has expired, then the UE may consider that DCI format message to be invalid and disregard it.

The retransmission is shown in dashed lines at 1734, 1744 in FIG. 17 to illustrate that the network might not actually send the retransmission. For example, the network may have another data block with a higher priority for transmission or retransmission. The network may, but need not necessarily, send a retransmission at a CRRO. In this sense a reception occasion is a “candidate” retransmission reception occasion, and a network device may selectively retransmit a data block. CRRO embodiments may be especially useful in longer propagation delay applications such as in NTN communications, because in such applications ACK/NAK feedback takes longer to reach a network device from a UE.

Thus, a CRRO defines a specific time-domain occasion (e.g., a PDSCH reception occasion), where a UE can expect a data block retransmission. Such time-domain occasions are defined relative to a transmission scheduled by a DCI format message carrying the CRRO field in some embodiments.

It should also be appreciated that there may be a relation between a CRRO and a TUD. A CRRO indicates a time-domain occasion at which a retransmission of a data block may be received, and in embodiments that also involve TUD it is desirable to not have such time-domain occasions for a data block defined beyond the TUD of the data block because the decoded bits of the would be flushed when the TUD expires.

In some embodiments, the retransmission 1734 of a data block may be scheduled by a DCI format message without a TUD field and without a CRRO field, in contrast to the first transmission 1732 of a data block which is scheduled by a DCI format message 1710 with a TUD field and with a CRRO field. Upon receiving the retransmission at 1744, the UE may perform decoding of the data block carried in retransmission 1744 by performing so-called soft combining of the retransmitted data block bits with the corresponding previously transmitted data block bits (from the data block in the first transmission 1732). It is assumed in the example shown that such processing related to soft combining is accounted for in the data block decoding time. If the UE correctly decoded the combined data block, then the UE forwards and delivers the decoded data block bits to the MAC layer, for disassembly and demultiplexing for example. If the UE has not correctly decoded the combined data block and the TUD of the data block is higher than zero, then the UE decrements the TUD of the data block by one. If the UE has not correctly decoded the combined data block and the TUD of the data block is equal to zero, then the UE flushes the decoded bits of the data block from its soft buffer.

In some embodiments, the retransmission 1734 of a data block is scheduled by a DCI format message sent by the network to the UE after the first transmission 1732 of the data block was received and correctly decoded by the UE. Different UE behaviors can be contemplated in such a scenario. In a first example: if the UE is scheduled to receive a retransmission 1734 of a data block after the UE received and correctly decoded the first transmission 1732 of the data block, then the UE drops the reception and decoding task of the retransmission in order to save power. In a second example: if the UE is scheduled to receive a retransmission 1734 of a data block after the UE received and correctly decoded the first transmission 1732 of the data block and it has correctly decoded the retransmission of the data block, then the UE forwards and delivers the decoded bits of the data block to the MAC layer, for disassembly and demultiplexing for example. In a third example: if the UE is scheduled to receive a retransmission 1734 of a data block after the UE received and correctly decoded the first transmission 1732 of the data block and it has not correctly decoded the retransmission of the data block, then the UE flushes the incorrectly decoded bits of the data block from its soft buffer.

Other data block (re) transmissions may be handled in a similar manner. For example, in the above embodiments, the retransmission 1734 may be replaced by a second retransmission, a third retransmission, an (n−1)-th retransmission where n is a non-zero integer number, and the first transmission 1732 may be replaced by a first retransmission, a second retransmission or an (n−2)-th retransmission.

In some embodiments, the network device may configure the UE with CRRO patterns using higher-layer signaling. As an example, assuming that the network device configured the UE with TUD=16, the network device may indicate CRROs by providing two CRRO patterns, each in the form of a 16-bit bitmap as follows:

```
SoftBuffer-Config = {
  crroConfig = {
    crroElement = {crroElementIdentity = 0, crroPattern = “0000000100010000”},
    crroElement = {crroElementIdentity = 1, crroPattern = “0001000100010000”}
}
```

Each crroElement in this example contains a crroPattern field, where the crroPattern field contains a bitmap whose size is based on a configured TUD value. The valid CRRO values correspond to the bit positions with a “1”, with the assumption that the left-most bit is the 1-st position of the bitmap. The network device may then use MAC-CE commands to activate or deactivate given CRRO patterns, which have the advantage of activating multiple CRRO values at once. As an example: if the CRRO pattern associated with crroElementIdentity=0 is activated, then the corresponding valid CRRO values are crroValue=8 and crroValue=12 because the pattern includes a “1” on the 8-th and 12-th positions of the crroPattern bitmap. The network device may then send a PDCCH transmission carrying a DCI format message to the UE, where the DCI format message may include CRRO=8 or CRRO=12. Other examples or variations can be contemplated.

Another embodiment of CRRO focuses on mixed traffic scheduling, where multiple traffic flows that have different QoS are involved. DCI format message and signaling options and examples provided above for CRRO may also or instead apply to mixed traffic scheduling embodiments, and as noted above the detailed signaling example illustrates that QoS features may also be implemented in conjunction with TUD and CRRO features.

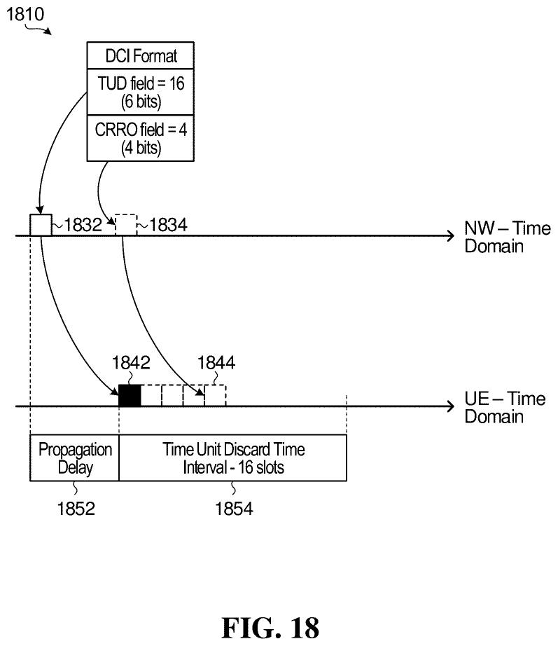

Consider again, as in another CRRO example above, that the network sends a MAC-CE command to the UE to activate two TUD values (e.g., 8 and 16) and two CRRO values (e.g., 4 and 8). FIG. 18 is a block diagram illustrating CRRO according to such an embodiment, in which the UE first receives a PDCCH transmission carrying a DCI format message 1810 that schedules a PDSCH transmission carrying a first transmission of a data block 1832, for which TUD=16 as shown at 1854, after a propagation delay 1852. This DCI format message also instructs the UE about a candidate slot indicated by CRRO=4 where a retransmission 1834 for the same data block may be received by the UE at 1844.

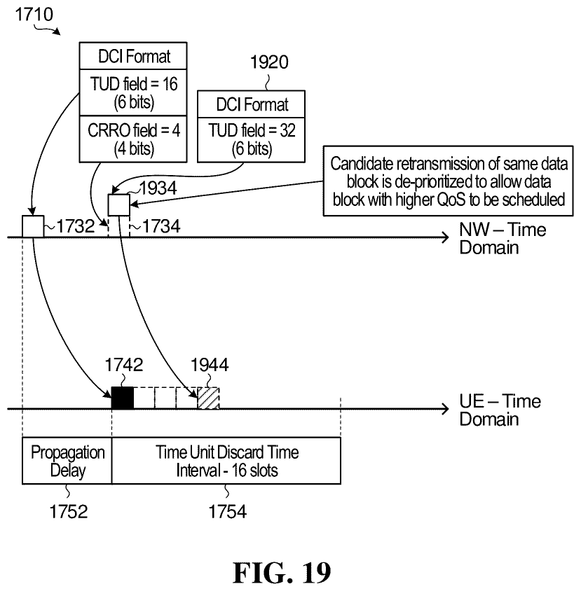

Due to mixed traffic conditions, the UE receives data bocks of traffic streams with different QOS at different slots. Although the DCI format message 1810 indicated a CRRO for a previously transmitted data block in the example shown in FIG. 18, consider a scenario in which a network device has another data block to transmit to the UE, and this other data block has a higher QoS requirement than the data block for which the CRRO is the particular slot indicated by the CRRO. In an embodiment, the higher QoS pre-empts the candidate retransmission that was indicated previously, and the network instead transmits a PDSCH transmission with a new transmission of the high QoS data block. This is shown as yet another example of CRRO in FIG. 19.

FIG. 19 is substantially the same as FIG. 17, but illustrates pre-emption of the CRRO for transmission of the data block 1732 by a higher QoS data block 1934 scheduled by a DCI format message 1920. FIGS. 17 and 19 illustrate that, at a CRRO, a UE may receive (and a network device may transmit) a retransmission of a data block as shown at 1744, 1734 in FIG. 17, or a transmission of a different data block as shown at 1944, 1934 in FIG. 19.

CRRO embodiments that are described with reference to FIGS. 17-19 relate to DL transmissions and retransmissions. CRRO may also or instead be applied to UE-to-UE communications, via sidelink (SL) transmissions for example.

Building on earlier embodiments, a DCI format message carried in a PDCCH transmission may include new fields to indicate TUD and CRRO. The time unit for the TUD and the CRRO may be, for example, any of: an OFDM symbol, a group of OFDM symbols, a mini-slot, a group of mini-slots, a slot, a group of slots, seconds, milli-seconds, micro-seconds, etc.

The network may configure a UE with values of the TUD and CRRO and may activate (or deactivate) values of TUD and CRRO, as described in further detail at least above. In a UE-to-UE embodiment, memory space management may be applied to scheduling SL transmissions.

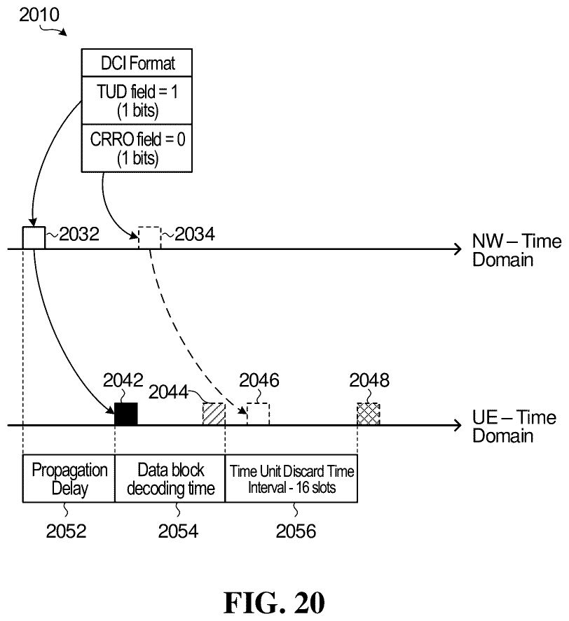

With reference to FIG. 20, which is a block diagram illustrating a further CRRO embodiment, suppose that a network device transmits a PDCCH transmission carrying a DCI format message 2010 scheduling a PDSCH transmission carrying a new transmission of a data block 2032.

The data block is first received in the DL soft buffer of the UE at 2042 after a propagation delay 2052. If the data block is correctly decoded by the UE at 2044 within the data block decoding time 2054, then the UE moves the decoded bits of the TB to its DL soft buffer dedicated for SL transmissions. Otherwise, the UE applies the TUD 2056 on the decoded bits of the data block and keeps the decoded bits in its DL soft buffer until the TUD expires. During that time, the network may attempt to retransmit the data block, depending on whether the first DCI format message included a CRRO field. A retransmission by the network device and reception by the UE are shown at 2034, 2046. Expiry of the TUD and flushing of the data block from the soft buffer are illustrated at 2048.

Consider a scenario in which the data block has been correctly decoded by the UE as shown at 2044 in FIG. 20, and the UE has moved the correctly decoded data block to its SL soft buffer for SL transmission to another UE. The TUD 2056 may still be applied by the UE in some embodiments, and the TUD indicates to the UE how long the UE has until it is to discard the data block. This mechanism ensures that the data block does not remain in the UE's soft buffer indefinitely, and the UE attempts to transmit the data block on the SL in a timely manner with respect to the TUD indicated by the network in the DCI format message 1810.

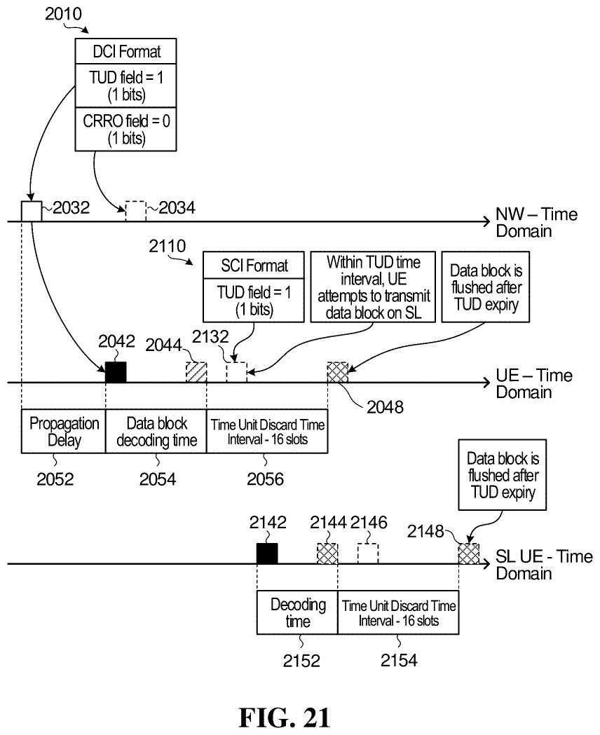

FIG. 21 is a block diagram illustrating application of TUD to communications between different UEs. Features 2010, 2032, 2034, 2042, 2044, and 2048 are the same in FIG. 21 as in FIG. 20. Reception of the retransmission 2034 by the UE is not shown in FIG. 21 in order to avoid further congestion in the drawing. Suppose that the UE correctly decodes the data block 2042 at 2044. The UE then schedules an SL transmission in some embodiments by transmitting a physical sidelink control channel (PSCCH) transmission carrying a sidelink control information (SCI) format message 2110. The SCI format message 2110 schedules a physical sidelink shared channel (PSSCH) transmission at 2132, carrying the data block that the UE decoded from the PDSCH transmission that was previously scheduled by the DCI format message 2010 transmitted by the network device. The SCI format message 2110 may carry a TUD value instructing the target UE to which the data block is to be transmitted over the SL, shown in FIG. 21 as SL UE, about how long the data block should stay in the target UE's soft buffer. The SL transmission is received at 2142, and may be correctly decoded at 2144 within the decoding time 2152.

2146 represents possible reception of a retransmission of the data block, and illustrates that a retransmission procedure may be provided for UE-to-UE communications. The corresponding retransmission by the UE is not shown in FIG. 21 in order to avoid further congestion in the drawing.

TUD 2154 is applied by the SL UE, and the data block is flushed from memory at 2148. TUD is applied at least in the event that the data block is not successfully decoded before the TUD expires.

Some embodiments disclosed herein relate to TUD, and may help improve memory space management, but allowing a UE to clear its soft buffer of decoded bits when the corresponding TUD expires, for example. Such features may leads to more efficient utilization of limited memory resources such as DL soft buffer space.

Memory status reporting, described by way of example in the context of SBSR, may allow a network device to know DL soft buffer occupancy or availability, for example, and to schedule transmission of new data blocks based on occupied or available space.

CRRO is an example of a selective retransmission feature that may be useful to allow a UE to know, ahead of time, one or more reception occasions at which a network device may send a PDCCH transmission scheduling a retransmission for a data block.

In some embodiments, a network device (e.g., a non-terrestrial TRP such as a satellite, or another network device) may configure a UE to periodically report current occupancy status of memory space in which data blocks are stored, by transmitting a report such as an SBSR in UCI over a PUCCH transmission for example. Periodicity of such reporting may be given in any of various units, such as seconds, milli-seconds, micro-seconds, nano-seconds, slots, mini-slots, OFDM symbols, etc. In another embodiment, occupancy status reporting is responsive to memory space occupancy, or occupancy of one or more portions of memory space such as partitions, reaching a threshold. Consider an example in which the UE is configured with a periodic SBSR configuration as follows:

```
SoftBuffer-Config = {
  SoftBufferStatusReport-Config = {
    periodicity = {20 slots},
    offset = {o slots},
    reportQuantization = {5 bits},
    reportType = {occupancy}
  }
}
```

The periodicity of such reporting may be given in any of various units, such as seconds, milli-seconds, micro-seconds, nano-seconds, slots, mini-slots, OFDM symbols, etc. The offset of the SBSR reporting may be defined relative to a reference slot in a frame structure, where the reference slot may be called “slot #0” for example, and an offset of an integer number n would correspond to the slot “slot #n−1”. The reportQuantization of the SBSR may be given in an integer number of bits. The SBSR report type may be defined as “occupancy”, where the occupancy is the ratio of:
the number of decoded bits stored in a partition of the buffer space at the time the UE is deriving the SBSR report, denoted as N_{decoded_bits}, and,
the total number of bits that can be stored in the corresponding partition of the buffer space, denoted as N_{total_bits}.

Alternatively the SBSR report type may be defined as “availability”, where the availability is the ratio of:
the difference between the total number of bits that can be stored in a partition of the buffer space and the number of decoded bits stored in the corresponding partition of the buffer space at the time the UE is deriving the SBSR report and,
the total number of bits that can be stored in the corresponding partition of the buffer space.

The occupancy may be calculated by the UE as follows in some embodiments:

$$OSBS = ⌊ \frac{{N}_{decoded \_ bits}}{{N}_{total \_ bits}} * {2}^{reportQuantization} ⌋ or$$

$$OSBS = ⌈ \frac{{N}_{decoded \_ bits}}{{N}_{total \_ bits}} * {2}^{reportQuantization} ⌉$$

where └·┘ is the floor function and ┌·┐ is the ceiling function. Consider an example in which the SBSR generated by the UE is as follows:

```
SoftBufferStatusReport = {
  eventType = {occupancy above threshold},
  OccupiedSoftBufferSpace = {19}
}
```

The eventType that triggers the SBSR report is set as “occupancy above threshold”, i.e. the occupancy of the buffer space is above a given threshold. The OccupiedSoftBufferSpace (OSBS) is a field which can carry an integer number from e.g. zero to 2^{reportQuantization}−1. The OccupiedSoftBufferSpace field is set to nineteen, i.e. the current occupancy of the high Qos buffer space is at sixty percent.

Based on the content of an SBSR or other report, the network device may transmit to the UE a PDCCH transmission carrying a DCI format message with a flushSoftBuffer field, in order to instruct the UE to flush its soft buffer. Consider an example in which the UE is configured with three QoS levels as follows:

```
SoftBufferConfig = {
  QoSList = {
    QoSListElement = {QoSValue = low},
    QoSListElement = {QoSValue = medium},
    QoSListElement = {QoSValue = high}
  }
}
```

The flushSoftBuffer field in the DCI format message may have a length of three bits, for example. Starting from the most significant bit (MSB), in an embodiment: the first bit is used to instruct the UE to flush the low QoS buffer space, the second bit is used to instruct the UE to flush the medium QoS buffer space, and the third bit is used to instruct the UE to flush the high QoS buffer space. As an example, the flushSoftBuffer field may have a value of ‘001’, which instructs the UE to flush the high QoS buffer space. This type of soft buffer flushing mechanism provides an example of an instruction to flush data block memory space, either partially or entirely, and allows the network device to fully or partially reset the UE's soft buffer in case of any inconsistencies or erroneous behavior on the part of the UE, for example. Current occupancy status reporting may allow the network device to verify and confirm which data block bits are still in the soft buffer (and/or which data block bits have been flushed from the soft buffer) at the time that an occupancy status report was generated by the UE and transmitted to the network device.

In some embodiments, a network device (a non-terrestrial TRP such as a satellite for example, or another network device) may configure a UE to report the current occupancy status of the memory space whenever specific events are triggered, by transmitting a report such as an SBSR in UCI over a PUCCH transmission for example. Periodicity of such reporting may be given in any of various units, such as seconds, milli-seconds, micro-seconds, nano-seconds, slots, mini-slots, OFDM symbols, etc., Consider an example in which the UE is configured with an event-triggered SBSR configuration as follows:

```
SoftBuffer-Config = {
  SoftBufferStatusReport-Config = {
    eventType = {occupancy above threshold},
    eventDuration = {20ms},
    eventThreshold = {50}
  }
}
```

The eventType that triggers the SBSR reporting is configured as “occupancy above threshold”, or in other words the occupancy of the high QoS buffer space is above a given threshold. The QoSLevel is configured with the value of “002” which corresponds to a high QoS level. The eventDuration provides a time-related condition for which the event must be true, for example for a duration of 20 milli-seconds the occupancy of the buffer space must be above a given threshold. Event durations may be given in any of various units, such as seconds, milli-seconds, micro-seconds, nano-seconds, slots, mini-slots, OFDM symbols, etc., The eventThreshold provides the threshold for the event, with the threshold for the occupancy of the buffer space set to fifty in this example, so that the threshold for the occupancy is fifty percent. Consider an example in which the SBSR generated by the UE is as follows:

```
Soft BufferStatusReport = {
  eventType = {occupancy above threshold},
  OccupiedSoftBufferSpace = {60}
}
```

The eventType that triggers the SBSR report is set as “occupancy above threshold”, to trigger the report when the occupancy of the buffer space is above a given threshold. The OccupiedSoftBufferSpace (OSBS) is a field which can carry an integer number, from zero to one hundred for example, to represent a percentage. The OccupiedSoftBufferSpace field is set to sixty in this example, to indicate that the current occupancy of the high QoS buffer space is at sixty percent. It should be noted that the UE may still be configured to send the SBSR with a quantized value in OccupiedSoftBufferSpace but in some embodiments the absence of the reportQuantization parameter SoftBufferStatusReport-Config causes the default operation for the UE to choose a value of OccupiedSoftBufferSpace from zero to one hundred.

In some embodiments, the event triggered reporting of the occupancy of the UE's buffer space may alternatively be based on the occupancy of a given partition of the buffer space, for example the high QoS buffer space. The eventType parameter may then be configured with a value of “occupancy above threshold”. The SoftBufferStatusReport-Config may further include a parameter, such as QoS with a value of “002” which corresponds to a high QoS level. The SBSR generated by the UE may further include a field, such as eventType, with a value equal to that of the eventType parameter in the SoftBufferStatusReport-Config. Consider an example in which the UE is configured with an event-triggered SBSR configuration as follows:

```
SoftBuffer-Config = {
  SoftBufferStatusReport-Config = {
    eventType = {occupancy above threshold},
    QoSLevel = {002},
    eventDuration = {20ms},
    eventThreshold = {50}
  }
}
```

The eventType that triggers the SBSR reporting is configured as “occupancy above threshold”, or in other words the occupancy of the high QoS buffer space is above a given threshold. The QoSLevel is configured with the value of “002” which corresponds to a high Qos level. The eventDuration provides a time-related condition for which the event must be true, for example for a duration of the 20 milli-seconds the occupancy of the buffer space must be above a given threshold. Event durations may be given in any of various units, such as seconds, milli-seconds, micro-seconds, nano-seconds, slots, mini-slots, OFDM symbols, etc., The eventThreshold provides the threshold for the event, with the threshold for the occupancy of the buffer space is set to fifty in this example, indicating that the threshold for the occupancy is fifty percent. Consider an example in which the SBSR generated by the UE is as follows:

```
SoftBufferStatusReport = {
  eventType = {occupancy above threshold},
  QoSLevel = {002},
  OccupiedSoftBufferSpace = {60}
}
```

The eventType that triggers the SBSR report is set as “occupancy above threshold”, which means that the occupancy of the buffer space is above a given threshold. The QoSLevel is set to the value of “002” which corresponds to the high QoS buffer space, or in other words the reported occupancy corresponds to the high QoS buffer space. The OccupiedSoftBufferSpace (OSBS) is a field which can carry an integer number, from zero to one hundred for example, to represent a percentage. The OccupiedSoftBufferSpace field is set to sixty, in this example, to indicate that the current occupancy of the high QoS buffer space is at sixty percent.

In some embodiments, the event triggered reporting of the occupancy of the UE's buffer space may alternatively be based on the occupancy of a given partition of the buffer space, e.g. the high QoS buffer space, the eventType parameter may then be configured with a value of “occupancy above threshold”. The SoftBufferStatusReport-Config may further include a parameter, e.g. QoS with a value of “002” which corresponds to a high QoS level. The SBSR generated by the UE may further include a field, such as eventType, with a value equal to that of the eventType parameter in the SoftBufferStatusReport-Config. Consider an example in which the UE is configures with an event-triggered SBSR configuration as follows:

```
SoftBuffer-Config = {
  SoftBufferStatusReport-Config = {
    eventType = {occupancy A above occupancy B},
    QoSLevelA = {002},
    QoSLevelB = {000},
    eventDuration = {20ms},
    eventThreshold = {50}
  }
}
```

The eventType that triggers the SBSR reporting is configured as “occupancy A above occupancy B”, or in other words the occupancy of the buffer space A is above the occupancy of the buffer space B. The QoSLevelA is configured with the value of “002” which corresponds to a high QoS level for buffer space A. The QoSLevelB is configured with the value of “000” which corresponds to a low QoS level for buffer space B. The eventDuration provides a time-related condition for which the event must be true, for example for a duration of the 20 milli-seconds the occupancy of the high QoS buffer space is above the occupancy of the low QoS buffer space. Event durations may be given in any of various units, such as seconds, milli-seconds, micro-seconds, nano-seconds, slots, mini-slots, OFDM symbols, etc., The eventThreshold provides the threshold for the event, and in this example the threshold for the occupancy of the low QoS buffer space is set to fifty to indicate that the threshold for the occupancy is fifty percent. Consider an example in which the SBSR generated by the UE is as follows:

```
SoftBufferStatusReport = {
  eventType = {occupancy A above occupancy B},
  QoSLevelA = {002},
  QoSLevelB = {000},
  OccupiedSoftBufferSpace = {60}
}
```

The eventType that triggers the SBSR report is set as “occupancy A above occupancy B”, to indicate that the occupancy of the buffer space A is above the occupancy of the buffer space B. The QoSLevelA is set to the value of “002” which corresponds to the high Qos buffer space, such that the reported occupancy corresponds to the high QoS buffer space. The QoSLevelB is set to the value of “000” which corresponds to the low QoS buffer space. The OccupiedSoftBufferSpace (OSBS) is a field which can carry an integer number, from zero to one hundred for example, to represent a percentage. The OccupiedSoftBufferSpace field is set to sixty, to indicate that the current occupancy of the high QoS buffer space is at sixty percent in this example, whereas the threshold for the event to be triggered in SoftBuffer-Config was configured to fifty percent.

In some embodiments, a UE reports its capability to send occupancy status reports, as part of a UE capability message for example. The UE uses the UE capability message to convey its radio access capability parameters, and the UE capability message may include a parameter, such as a softBufferStatusReporting parameter, with one or more values such as {supported, periodic, semi-static, aperiodic}. The presence of softBufferStatusReporting in a UE capability message with a value of supported, in this example, means that the UE supports the feature of transmitting reports such as SBSRs. The presence of softBufferStatusReporting in the UE capability message with a value of periodic, in this example, means that the UE supports the feature of transmitting reports such as SBSRs periodically. The presence of softBufferStatusReporting in the UE capability message with a value of semi-static, in this example, means that the UE supports the feature of transmitting reports such as SBSRs semi-statically. The presence of softBufferStatusReporting in the UE capability message with a value of aperiodic, in this example, means that the UE supports the feature of transmitting reports such as SBSRs aperiodically.

In some embodiments, the UE reports its capability to receive and decode data block such as TBs, scheduled by a DCI format message carrying a timeUntilDiscard field, as part of its UE capability message. The UE uses the UE capability message to convey its radio access capability parameters, and the UE capability message may include a parameter, such as tudBasicOperation for example, with one or more values, such as {supported} for example. The presence of tudBasicOperation in the UE capability message with a value of supported in this example means that the UE supports the feature of receiving and decoding data blocks scheduled by a DCI format message carrying a timeUntilDiscard field.

In some embodiments, the UE reports its capability to dynamically flush data block bits in its soft buffer or other data block memory space, based on a DCI format message carrying a flushSoftBuffer field, as part of its UE capability message. The UE uses the UE capability message to convey its radio access capability parameters as noted at least above, and the UE capability message may include a parameter, such as softBufferFlushing for example, with one or more values, such as {supported, partial, qosBased}, for example. The presence of softBufferFlushing in the UE capability message with a value of supported, in this example, means that the UE supports the feature of dynamically flushing data block bits in its soft buffer or other data block memory space, based on a DCI format message carrying a flushSoftBuffer field. The presence of softBufferFlushing in the UE capability message with a value of partial, in this example, means that the UE supports the feature of dynamically flushing some data block bits in its soft buffer or other data block memory space, based on a DCI format message carrying a flushSoftBuffer field. The presence of softBufferFlushing in the UE capability message with a value of qosBased, in this example, means that the UE supports the feature of dynamically flushing data block bits associated with a given QoS in its soft buffer or other data block memory space, based on a DCI format message carrying a flushSoftBuffer field.

In some embodiments, the UE reports the time it takes to decode data blocks, which is referred to as the data block decoding time, as part of its UE capability message. The data block decoding time may be given in any of various units, such as seconds, milli-seconds, micro-seconds, nano-seconds, slots, mini-slots, OFDM symbols, etc. The UE capability message may include a parameter such as dataBlockDecodingTime with one value, {100 μs} for example. The presence of one value of dataBlockDecodingTime in the UE capability message with a value of 100 μs, for example, means that the UE supports a data block decoding time of a 100 micro-seconds. The UE capability message may include a parameter such as dataBlockDecodingTime with more than one value, such as {100 μs, 200 μs, 500 μs}, and another parameter such as dataBlockSize with more than one value, {1000, 10000, 100000} for example. The presence of dataBlockDecodingTime and dataBlockSize in the UE capability message means that the UE supports a given data block decoding time for data blocks with a number of bits up to a given size. As an example, the value of 100 micro-seconds of data block decoding time is associated with a size of up to 1000 bits, the value of 200 micro-seconds of data block decoding time is associated with a size of up to 10000 bits, the value of 500 micro-seconds of data block decoding time is associated with a size of up to 100000 bits.

In some embodiments, the CRRO value may alternatively indicate one or more TUD values corresponding to PDSCH reception occasions where a network device may transmit PDSCH transmissions carrying a retransmission of a previously transmitted TB. As an example, the network device (a non-terrestrial TRP such as a satellite for example, or another network device) may send a PDCCH transmission carrying a DCI format message with TUD=16 and CRRO=12. This DCI format message schedules a PDSCH transmission carrying a first transmission of a TB, for which TUD=16. This DCI format also instructs the UE about a candidate PDSCH reception occasion indicated by CRRO=12. This PDSCH reception occasion is the one where the TUD of the corresponding TB reaches the value of 12, under the assumption that the first transmission of the TB was not decoded correctly by the UE. If the network device sends a PDCCH transmission carrying a DCI format message scheduling a retransmission of a previously transmitted TB in a PDSCH reception occasion that is inconsistent or conflicting with the indicated CRRO=12, then the UE may treat the DCI format message as invalid, which results in the UE discarding all the information in the DCI format message and not performing reception and decoding of the corresponding PDSCH transmission.

In some embodiments, a network device may configure a UE to periodically report the occupancy of the soft buffer using SBSRs, every five slots for example, and the value of the occupancy of the soft buffer is calculated as the instantaneous occupancy measured by the UE at the time instant it carried out its measurement of the occupancy of the soft buffer. As an example, if the UE is configured to transmit the SBSR at slot s=10, the OccupiedSoftBufferSpace value will be equal to the occupancy of the soft buffer at slot s=10. The occupancy of the soft buffer may be measured at the beginning of slot s=10 when any data blocks whose TUD is equal to zero have not yet been flushed from the soft buffer. The occupancy of the soft buffer may alternatively be measured at the end of slot s=10 when data blocks whose TUD is equal to zero have been flushed from the soft buffer.

In some embodiments, a network device may configure a UE to periodically report the occupancy of the soft buffer using SBSRs, every five slots for example, and the value of the occupancy of the soft buffer is calculated as the average occupancy measured by the UE at each time instant it carried out a measurement of the occupancy of the soft buffer, where the average is over the slots between the last periodic soft buffer report and the current periodic soft buffer report. As an example, if the UE is configured to transmit the SBSR at slot s=10, the OccupiedSoftBufferSpace value will be equal to the average occupancy of the soft buffer, averaged over slots={6, 7, 8, 9, 10}. The occupancy of the soft buffer may be measured at the beginning of a slot when data blocks whose TUD is equal to zero have not yet been flushed from the soft buffer. The occupancy of the soft buffer may alternatively be measured at the end of a slot when data blocks whose TUD is equal to zero have been flushed from the soft buffer.

In some embodiments, a network device may configure a UE to periodically report the occupancy of the Soft Buffer using SBSRs, every five slots for example, and the value of the occupancy of the soft buffer is calculated as a filtered occupancy measured by the UE at the time instant it carried out its measurement of the occupancy of the soft buffer. As an example, the filtered occupancy may be calculated using the following equation:

$${FOSBS}_{n} = ( 1 - α ) * {FOSBS}_{n - 1} + α * {OSBS}_{n}$$

where OSBSₙ is the latest instantaneous occupancy of the soft buffer measured by the UE, FOSBSₙ is the updated filtered occupancy measurement of the soft buffer that is used for soft buffer occupancy reporting and FOSBSₙ₋₁ is the old filtered occupancy measurement of the soft buffer. α is the filtering coefficient which can be configured by the network device to the UE using higher layer signaling (such as RRC signaling) as a real value between zero and one, for example {0; 0.001; 0.002; . . . ; 1}. At an initialization step, the updated filtered occupancy measurement may be set to the latest instantaneous occupancy, FOSBS₁=OSBS₁ and FOSBS₀=0 (to reflect the assumption that the soft buffer is initially empty).

In some embodiments, the UE may generate a bitstream carrying the SBSR bits and multiplex those SBSR bits with the bitstream carrying the data block bits to be transmitted on a Physical Uplink Shared Channel (PUSCH) transmission. This may happen when the UCI to be carried in a corresponding PUCCH exceeds a certain threshold, or in other words the number of UCI bits exceeds a certain threshold. The SBSR bits may be channel coded using, for example, Polar coding, low density parity check (LDPC) coding, Turbo coding, Convolutional coding, etc., and then mapped on a dedicated set of resource elements that belong to the set of resource elements allocated for the PUSCH transmission.

Various embodiments are described in detail herein, and encompass embodiments related to storage of data blocks for up to a maximum period of time to support a data block retransmission procedure (TUD, for example), reporting of data block memory space occupancy status (SBSR for soft buffer, for example), and selective retransmission (using CRRO, for example).

These aspects may be implemented independently from each other, or in any of various combinations. TUD values may be associated with QoS values, CRRO may be used to indicate to a UE when a network device may send a transmission to schedule a retransmission of a data block for which the corresponding TUD has not yet expired, or QoS may be taken into account for selective retransmission associated with a CRRO, for example.

A method according to one aspect of the present disclosure involves receiving, by a UE, signaling that indicates a maximum time period during which a data block that is to be communicated in a wireless communication network may remain in memory space at the UE to support a data block retransmission procedure. This signaling may be or include DCI in some embodiments, and various examples of DCI format messages are provided elsewhere herein. TUD is an example of such a maximum time period, and a soft buffer is an example of memory space in which a data block may be stored.

A data block retransmission procedure may involve the UE attempting to decode a data block, and possibly receiving one or more retransmissions of a data block to enable the UE to attempt to decode the data block multiple times. It should be appreciated, however, that a data block retransmission procedure is not limited to reception and decoding of data blocks by a UE. Although such a procedure may be applicable to DL communications, in other embodiments such as UL and SL communications a UE may instead be a transmitter of a data block, and a data block may be stored in the memory space at the UE to support a data block retransmission procedure that involves the UE retransmitting the data block.

From a network device perspective, a method may involve a counterpart operation of transmitting such signaling to a UE by the network device. Storage of a data block to the memory space at the UE may support a data block retransmission procedure from the network device perspective in that the previous transmission(s) of the data block remain in the memory space at the UE so that the UE may be better able properly decode the data block based on multiple transmissions instead of only a single transmission.

Reception and transmission of such signaling is shown by way of example in FIG. 6, at 606. In FIG. 6, maximum time values in the form of TUD values are configured at 602 and then activated at 604, but this is only one possibility. Separate configuration and activation is not necessarily implemented in all embodiments. PDCCH signaling is also one illustrative example of signaling that may indicate the maximum time period referenced above. The DCI format messages including TUD fields, as shown in FIGS. 7, 8, and 17 to 21, are also examples of such signaling.

Whether signaling that indicates a maximum time period is received by a UE or transmitted by a network device, methods may also involve communicating the data block in the wireless communication network, by the UE and/or by the network device. For DL communications, communicating the data block may involve receiving and decoding the data block by the UE and transmitting the data block to the UE by the network device. For UL communications, communicating the data block may involve receiving and decoding the data block by the network device from the UE and transmitting the data block to the network device by the UE. For SL communications, communicating the data block may involve transmitting the data block by one the UE to another UE and receiving and decoding the data block by the other UE from the UE. In this example, the UE that transmits the data block may also receive and decode the data block, from a network device for example. Various examples of transmitting and receiving data blocks are provided herein, at least in FIGS. 6 to 8 and 17 to 21 and the descriptions thereof.

The maximum time period may, but need not be, explicitly indicated in signaling. Signaling may be or include an implicit indication or an explicit indication of the maximum time period.

As illustrated by way of example in FIGS. 7 and 8, the maximum time period may begin before or after a data block decoding time. Put another way, the maximum time period may include a decoding time required by the UE to decode the data block, or may begin after a decoding time required by the UE to decode the data block.

When the maximum time period expires, the data block retransmission procedure may or may not have been successfully completed with correct decoding of the data block. The data block may therefore be flushed from the memory space on expiry of the maximum time period before successful completion of the data block retransmission procedure. A UE-based method, for example may involve flushing the data block from the memory space on expiry of the maximum time period before successful completion of the data block retransmission procedure.

Memory space occupancy status reporting may be implemented in conjunction with these and/or any other time period-related features disclosed herein. For example, a method may include transmitting, by a UE to a network device by which a data block is to be transmitted to the UE, signaling to indicate a current occupancy status of the memory space. From a network device perspective, a method may involve receiving, from a UE, such signaling to indicate the current occupancy status. An SBSR, in UCI for example, is one form of occupancy status signaling disclosed herein, and FIGS. 12 and 16 provided detailed examples. Other features related to occupancy status reporting are disclosed herein and may be implemented in conjunction with time period-related features, or separately.

In some embodiments, the signaling that indicates the maximum time period is received by the UE (and/or transmitted by the network device) after the UE transmits (or the network device receives) the signaling to indicate the current occupancy status of the memory space. This may provide the network device with better control over usage of the UE memory space or at least enable the network device to make more informed determinations as to transmitting data blocks to the UE, for example.

Signaling to indicate current occupancy status of memory space may take any of various forms. For example, such signaling may include respective indications of occupancy status for each of a number of partitions of the memory space, such as those shown by way of example in FIGS. 9 to 16. These examples in FIGS. 11, 12, 15, and 16 are illustrative of embodiments in which partitions, also referred to herein as sub-partitions, are associated with respective different QOS requirements of different traffic flows.

Different maximum time periods may be associated with the different Qos requirements, as referenced herein at least in the context of different TUDs associated with different QoS levels. A maximum time period that is indicated in signaling that is received by a UE and/or transmitted by a network device may be one of a number of respective maximum time periods associated with the different QoS requirements. Any or all of such maximum time periods may be indicated in signaling.

A transmitter of a data block, which may be a UE or a network device, may selective retransmit a data block or transmit a different data block, as perhaps shown more clearly in FIGS. 18 and 19. In FIG. 18, the network device retransmits the data block 1832 at 1834, but in FIG. 19 a different data block with a higher QoS is transmitted. A transmitter may thus be considered as selectively transmitting a different data block or selectively retransmitting a previously transmitted data block.

Features related to selective (re) transmission may be implemented in conjunction with maximum time period-related features and/or memory occupancy status reporting features, or separately. In some embodiments, the signaling that indicates the maximum time period further indicates a candidate occasion at which the UE may receive a retransmission of the data block. This is disclosed by way of example herein in the form of DCI format messages that include both a TUD value and a CRRO value. FIG. 6 also illustrates at 606 that signaling may indicate both a TUD value and a CRRO value. This is not necessarily the case in all embodiments, and CRRO may be indicated in separate signaling.

Whether a candidate occasion is indicated in the same signaling as the maximum time period or in separate signaling, a method may involve receiving, by the UE at the candidate occasion, a retransmission of the same data block or a transmission of a different data block, and/or transmitting by the network device to the UE at the candidate occasion, a retransmission of the same data block or a transmission of a different data block. Candidate occasions may also or instead be implemented for UE-to-UE communications, in which case a method may involve one UE transmitting, and another UE receiving, a retransmission of the same data block or a transmission of a different data block at the candidate occasion.

Other features disclosed herein similarly are not in any way restricted to implementation only in respect of communications between a network device and a UE. Maximum time period-related features and/or candidate occasion features may be provided for UE-to-UE communications, as disclosed by way of example at least in FIGS. 20 and 21 and the descriptions thereof. Memory space occupancy reporting is disclosed herein primarily in the context of a UE report to a network device, but may also or instead be implemented between UEs.

Methods related to occupancy status may involve, for example, receiving, by a UE from a network device in a wireless communication network (and/or transmitting, to a UE by network device), a data block that is to be stored in memory space at the UE to support a data block retransmission procedure, and transmitting by the UE to the network device (and/or receiving by the network device from the UE), signaling to indicate a current occupancy status of the memory space. Such transmitting and/or receiving may be between UEs for UE-to-UE communications.

Transmitting (and/or receiving) signaling to indicate the current occupancy status of the memory space may involve transmitting (and/or receiving) the signaling periodically or responsive to the memory space occupancy reaching a threshold.

Any of various actions may be initiated based on memory space occupancy status. Full memory space flushing or partial flushing based on QoS level or other memory space partitions or sub-partitions, for example, may be triggered based on current occupancy status. In some embodiments, a method may involve receiving, by the UE from the network device after transmitting the signaling to indicate the current occupancy status of the memory space, an instruction based on the current occupancy status to flush the memory space. From the network device perspective, a method may involve transmitting, to the UE by the network device after receiving the signaling to indicate the current occupancy status of the memory space, an instruction based on the current occupancy status to flush the memory space. Examples of such an instruction are provided elsewhere herein, including a three-bit instruction as an illustrative example for three QoS levels, and the memory space is flushed in accordance with the instruction. At a UE side, and method may include flushing the memory space in accordance with the instruction. Again, as for other features, an instruction to fully or partially flush memory space may be transmitted and/or received between UEs for UE-to-UE communications.

Other memory space occupancy status features disclosed herein may be provided or supported whether memory space occupancy status reporting is implemented separately from or in conjunction with maximum time period-related features and/or retransmission reception occasion features. For example, signaling may be or include respective indications of occupancy status for each of a number of partitions of the memory space, which partitions may be associated with respective different QoS requirements of different traffic flows in some embodiments. The partitions may also or instead have respective associated maximum time periods during which data blocks may remain in the partition.

In an embodiment that provide maximum time period-related features, a method may involve receiving by the UE from the network device (and/or transmitting to the UE by the network device), signaling that indicates a maximum time period during which the data block may remain in the memory space to support the data block retransmission procedure. In the case of multiple time periods, for different memory space partitions for example, any or each of the maximum time periods may be indicated in signaling that is transmitted and/or received. It should also be noted that, as with other features disclosed herein, signaling that indicates the maximum time period(s) may be transmitted and/or received between UEs for UE-to-UE communications.

Maximum time period-related features that are disclosed in the context of other embodiments may also or instead be provided or supported in embodiments that involve occupancy status reporting, such as any one or more of the following, in any of various combinations:
the signaling that indicates the maximum time period is received by the UE (and/or transmitted by the network device) after the UE transmits (or the network device receives) the signaling to indicate the current occupancy status of the memory space;
the signaling that indicates the maximum time period is or includes an implicit indication or an explicit indication of the maximum time period;
the maximum time period includes a decoding time required by the UE to decode the data block;
the maximum time period begins after a decoding time required by the UE to decode the data block;
the data block is flushed from the memory space on expiry of the maximum time period before successful completion of the data block retransmission procedure, in which case a UE-based method may involve flushing the data block from the memory space on expiry of the maximum time period before successful completion of the data block retransmission procedure.

Similarly, retransmission reception occasion features that are disclosed in the context of other embodiments may also or instead be provided or supported in embodiments that involve occupancy status reporting, such as any one or more of the following:
receiving by the UE from the network device or another UE (and/or transmitting to the UE by the network device or the other UE), signaling that indicates a candidate occasion at which the UE may receive a retransmission of the data block;
receiving by the UE (and/or transmitting by the network device or the other UE) at the candidate occasion, the retransmission of the data block or a transmission of a different data block.

The foregoing examples of method embodiments are not intended to be exhaustive. Other embodiments include apparatus embodiments and embodiments related to computer program products. An apparatus may include, for example, a processor and a non-transitory computer readable storage medium, coupled to the processor, storing programming for execution by the processor. A computer program product may be or include a non-transitory computer readable medium storing programming for execution by a processor. The programming includes instructions to, or to cause a processor to, perform any of various operations.

The programming for some UE-based embodiments, for example, includes instructions to, or to cause a processor to: receive, by a UE in a wireless communication network, signaling that indicates a maximum time period during which a data block that is to be communicated in the wireless communication network may remain in memory space at the UE to support a data block retransmission procedure; and communicate, by the UE, the data block in the wireless communication network. For some network device-based embodiments, the programming may include instructions to, or to cause a processor to: transmit, to a UE by a network device in a wireless communication network, signaling that indicates a maximum time period during which a data block that is to be communicated with the UE may remain in memory space at the UE to support a data block retransmission procedure; and communicate the data block, by the network device with the UE.

Features disclosed elsewhere herein may be provided or supported in any of these embodiments. For example, any one or more of the following may be implemented or supported, in any of various combinations:
the signaling that indicates the maximum time period comprises an implicit indication or an explicit indication of the maximum time period;
the programming includes instructions to, or to cause a processor to, communicate the data block by receiving and decoding the data block by the UE (and/or by transmitting the data block by the network device to the UE);
the maximum time period includes a decoding time required by the UE to decode the data block;
the maximum time period begins after a decoding time required by the UE to decode the data block;
the data block may be flushed from the memory space on expiry of the maximum time period before successful completion of the data block retransmission procedure, and in a UE-based embodiment the programming may include instructions to, or to cause a processor to, flush the data block from the memory space on expiry of the maximum time period before successful completion of the data block retransmission procedure;
the programming may include instructions to, or to cause a processor to, transmit by the UE to a network device by which the data block is to be transmitted to the UE (and/or receive by such a network device from the UE), signaling to indicate a current occupancy status of the memory space;
the signaling that indicates the maximum time period is received by the UE (and/or transmitted by the network device to the UE) after the UE transmits (or the network device receives) the signaling to indicate the current occupancy status of the memory space;
the signaling to indicate the current occupancy status of the memory space comprises respective indications of occupancy status for each of a number of partitions of the memory space;
the partitions are associated with respective different QoS requirements of different traffic flows;
the maximum time period is or includes one (or each) of a number of respective maximum time periods associated with the different QoS requirements;
the signaling that indicates the maximum time period further indicates a candidate occasion at which the UE may receive a retransmission of the data block;
the programming may include instructions to, or to cause a processor to, receive by the UE (and/or transmit to the UE by the network device), signaling that indicates a candidate occasion at which the UE may receive a retransmission of the data block;
the programming may include instructions to, or to cause a processor to, receive by the UE (and/or transmit to the UE by the network device) at the candidate occasion, the retransmission of the data block or a transmission of a different data block.

Programming for some UE-based embodiments related to occupancy status reporting includes instructions to, or to cause a processor to: receive, by a UE from a network device in a wireless communication network, a data block that is to be stored in memory space at the UE to support a data block retransmission procedure; and transmit, by the UE to the network device, signaling to indicate a current occupancy status of the memory space. For some related network device-based embodiments, the programming may include instructions to, or to cause a processor to: transmit, to a UE from a network device in a wireless communication network, a data block that is to be stored in memory space at the UE to support a data block retransmission procedure; and receive, by the network device from the UE, signaling to indicate a current occupancy status of the memory space.

Features disclosed elsewhere herein may be provided or supported in any of these embodiments. For example, any one or more of the following may be implemented or supported, in any of various combinations:
the programming includes instructions to, or to cause a processor to, transmit (and/or receive) the signaling to indicate the current occupancy status of the memory space periodically or responsive to the memory space occupancy reaching a threshold;
the programming includes instructions to, or to cause a processor to, receive by the UE from the network device (and/or transmit to the UE by the network device) after transmitting (or receiving) the signaling to indicate the current occupancy status of the memory space, an instruction based on the current occupancy status to flush the memory space;
the memory space is flushed in accordance with the instruction, in which case programming for a UE-based embodiment may include instructions to, or to cause a processor to, flush the memory space in accordance with the instruction;
the signaling is or includes respective indications of occupancy status for each of a number of partitions of the memory space;
the partitions are associated with respective different QoS requirements of different traffic flows;
the partitions have respective associated maximum time periods during which data blocks may remain in the partition;
the programming includes instructions to, or to cause a processor to, receive by the UE from the network device (and/or transmit to the UE by the network device), signaling that indicates a maximum time period during which the data block may remain in the memory space to support the data block retransmission procedure;
the signaling that indicates the maximum time period is received by the UE (and/or transmitted by the network device to the UE) after the UE transmits (or the network device receives) the signaling to indicate the current occupancy status of the memory space;
the signaling that indicates the maximum time period comprises an implicit indication or an explicit indication of the maximum time period;
the maximum time period includes a decoding time required by the UE to decode the data block;
the maximum time period begins after a decoding time required by the UE to decode the data block;
the data block may be flushed from the memory space on expiry of the maximum time period before successful completion of the data block retransmission procedure, and in a UE-based embodiment the programming may include instructions to, or to cause a processor to, flush the data block from the memory space on expiry of the maximum time period before successful completion of the data block retransmission procedure;
the programming may include instructions to, or to cause a processor to, receive by the UE (and/or transmit to the UE by the network device), signaling that indicates a candidate occasion at which the UE may receive a retransmission of the data block;
the programming may include instructions to, or to cause a processor to, receive by the UE (and/or transmit to the UE by the network device) at the candidate occasion, the retransmission of the data block or a transmission of a different data block.

Variations of these example method, apparatus, and computer program product embodiments are possible. For example, features described in the context of these embodiments may be implemented in any of various ways as disclosed herein, and features that are described with reference to one embodiment may also or instead be provided or supported in other embodiments.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

Other variations are also possible. For example, TBs are identified above as one example of data blocks. It should be appreciated, however, that features disclosed herein may be applied to other types of data blocks, including code blocks (CBs) or code block groups (CBGs). A code block (CB) is defined as a sequence of individually coded bits that are output by a channel encoder, such as a Polar encoder, an LDPC encoder, a Turbo encoder, a convolutional encoder, etc., A code block group (CBG) is defined as a group of CBs that are output by a channel encoder, such as a Polar encoder, an LDPC encoder, a Turbo encoder, a convolutional encoder, etc., As an example 1 TB may include 10 CBs, each with parity bits, and if 9 of the 10 CBs are decoded correctly then those 9 correctly decoded CBs could be removed from a DL soft buffer and only the 1 CB that was not decoded correctly then remains in the soft buffer. This example illustrates that features need not be applied only on a per-TB level. A data block may be, but is not in any way limited to a TB. More generally features herein may be applied to TBs, CBS, CBGs, etc. The present disclosure is not in any way limited only to TBs.

Similarly, embodiments are disclosed primarily with reference to DL communications, and to some extent SL communications. Disclosed features may also or instead be applied to UL communications. For example, a network device may transmit not only an uplink grant to a UE, for the UE to send a data block of a certain size, but also a UL TUD. At the UE side, the MAC layer will supply MAC protocol data units from which TBs are generated. In this case the content of a TB is from a MAC PDU at the UE and would not be decoded at the UE, but may still be buffered at the UE for transmission in uplink. For uplink, a TUD relates to how long transmit data is held in a transmit buffer, for possible retransmission, before being cleared or flushed from the buffer.

Embodiments disclosed herein also are not restricted to any particular type of wireless communications, and may be applied, for example, to other radio access technologies such as Wi-Fi.

What is claimed is:

1. A method comprising:
receiving, by a user equipment (UE) in a wireless communication network, signaling that indicates a maximum time period during which a data block that is to be communicated in the wireless communication network is allowed to remain in memory space of the UE to support a data block retransmission procedure; and
communicating, by the UE, the data block in the wireless communication network.

2. The method of claim 1, wherein the signaling implicitly indicates the maximum time period or comprises an explicit indication of the maximum time period.

3. The method of claim 1, wherein the communicating comprises receiving and decoding the data block, and wherein the maximum time period includes a decoding time required by the UE to decode the data block.

4. The method of claim 1, wherein the communicating comprises receiving and decoding the data block, and wherein the maximum time period begins after a decoding time required by the UE to decode the data block.

5. The method of claim 1, further comprising:
flushing the data block from the memory space of the UE on expiry of the maximum time period before successful completion of the data block retransmission procedure.

6. The method of claim 1, further comprising:
transmitting, by the UE to a network device by which the data block is to be transmitted to the UE, signaling indicating a current occupancy status of the memory space.

7. A method comprising:
transmitting, to a user equipment (UE) by a network device in a wireless communication network, signaling that indicates a maximum time period during which a data block that is to be communicated with the UE is allowed to remain in memory space of the UE to support a data block retransmission procedure; and
communicating the data block by the network device with the UE.

8. The method of claim 7, wherein the signaling implicitly indicates the maximum time period or comprises an explicit indication of the maximum time period.

9. The method of claim 7, wherein the communicating comprises transmitting the data block to the UE, and wherein the maximum time period includes a decoding time required by the UE to decode the data block.

10. The method of claim 7, wherein the communicating comprises transmitting the data block to the UE, wherein the maximum time period begins after a decoding time required by the UE to decode the data block.

11. The method of claim 7, wherein the data block is to be flushed from the memory space on expiry of the maximum time period before successful completion of the data block retransmission procedure.

12. The method of claim 7, further comprising:
receiving, by the network device from the UE, signaling indicating a current occupancy status of the memory space of the UE.

13. An apparatus comprising:
at least one processor; and
at least one non-transitory computer readable storage medium, coupled to the at least one processor, storing programming for execution by the at least one processor, the programming including instructions to:
receive signaling that indicates a maximum time period during which a data block that is to be communicated in a wireless communication network is allowed to remain in memory space at the apparatus to support a data block retransmission procedure; and
communicate the data block in the wireless communication network.

14. The apparatus of claim 13, wherein the signaling implicitly indicates the maximum time period or comprises an explicit indication of the maximum time period.

15. The apparatus of claim 13, wherein the programming includes instructions to communicate the data block by receiving and decoding the data block, and wherein the maximum time period includes a decoding time required by the apparatus to decode the data block.

16. The apparatus of claim 13, wherein the programming includes instructions to communicate the data block by receiving and decoding the data block, and wherein the maximum time period begins after a decoding time required by the apparatus to decode the data block.

17. An apparatus comprising:
at least one processor; and
at least one non-transitory computer readable storage medium, coupled to the at least one processor, storing programming for execution by the at least one processor, the programming including instructions to:
transmit, to a user equipment (UE) in a wireless communication network, signaling that indicates a maximum time period during which a data block that is to be communicated with the UE is allowed to remain in memory space of the UE to support a data block retransmission procedure; and
communicate the data block, by the apparatus with the UE.

18. The apparatus of claim 17, wherein the signaling implicitly indicates the maximum time period or comprises an explicit indication of the maximum time period.

19. The apparatus of claim 17, wherein the programming includes instructions to communicate the data block by transmitting the data block to the UE, and wherein the maximum time period includes a decoding time required by the UE to decode the data block.

20. The apparatus of claim 17, wherein the programming includes instructions to communicate the data block by transmitting the data block to the UE, and wherein the maximum time period begins after a decoding time required by the UE to decode the data block.
